(19) United States
(12) Patent Application Publication
(10) Pub. No.: US 2025/0030006 A1
(43) Pub. Date: Jan. 23, 2025

(54) Modified Current Collector for Secondary Battery

(71) Applicant: GRST International Limited, Hong Kong (CN)

(72) Inventors: Kam Piu Ho, Hong Kong (CN); Yingkai Jiang, Shenzhen (CN); Priscilla Huen, Hong Kong (CN)

(21) Appl. No.: 18/714,566

(22) PCT Filed: Jul. 28, 2022
(86) PCT No.: PCT/CN2022/108701

§ 371 Date: May 30, 2024

(30) Foreign Application Priority Data
Dec. 2, 2021 (WO) PCT/CN2021/134986
Dec. 16, 2021 (WO) PCT/CN2021/138811

(51) Int. Cl. H01M 4/66; H01M 4/02; H01M 4/131; H01M 4/62

(52) U.S. Cl. CPC H01M 4/667; H01M 4/131; H01M 4/622; H01M 4/663; H01M 4/668; H01M 2004/028

(57) ABSTRACT

A modified current collector for a secondary battery is disclosed herein, comprising a substrate and a conductive layer applied on one side or both sides of the substrate, wherein the conductive layer comprises a conductive material, a binder material comprising a polymer, and a metal compound, and may additionally comprise a particulate material. Also provided herein is a cathode for a secondary battery, comprising the modified current collector and an electrode layer, wherein the electrode layer is located on the surface of the conductive layer. The presence of the conductive layer inhibits corrosion of the substrate and reduces interfacial resistance between the electrode layer and the substrate. In addition, the metal compound in the conductive layer reduces irreversible capacity loss due to SEI formation during initial charging of the battery. Consequently, batteries comprising the modified current collector exhibit exceptional electrochemical performance.

### CROSS-REFERENCE TO RELATED APPLICATIONS

This is a U.S. national stage application of the International Patent Application No. PCT/CN2022/108701, filed Jul. 28, 2022, which claims the benefit under 35 U.S.C. § 365(c) of International Patent Application No. PCT/CN2021/134986, filed Dec. 2, 2021 and International Patent Application No. PCT/CN2021/138811, filed Dec. 16, 2021, the content of all of which are incorporated herein by reference in their entireties.

### FIELD OF THE INVENTION

The present invention relates to the field of batteries. In particular, this invention relates to a modified current collector in a cathode in a secondary battery.

### BACKGROUND OF THE INVENTION

Among various types of batteries, lithium-ion batteries (LIBs) in particular have become widely utilized for various applications over the past decades, especially in consumer electronics, because of their outstanding energy density, long cycle life and high discharging capability. Due to rapid market development of electric vehicles (EV) and grid energy storage, high-performance, low-cost LIBs are currently offering one of the most promising options for large-scale energy storage devices. However, many problems still exist in current lithium-ion battery technology, more specifically with respect to lithium-ion battery electrodes.

Generally, lithium-ion battery electrodes are manufactured by casting an organic-based slurry onto a current collector. The slurry contains electrode active material, conductive carbon, and binder in an organic solvent. The binder provides a good electrochemical stability, holds together the electrode active materials and adheres them to the current collector in the fabrication of electrodes. Polyvinylidene fluoride (PVDF) is currently one of the most commonly used binders in the commercial lithium-ion battery industry. However, PVDF is insoluble in water and can only dissolve in some specific organic solvents such as N-methyl-2-pyrrolidone (NMP) which is flammable and toxic and hence requires specific handling.

An NMP recovery system must be in place during the drying process to recover NMP vapors. This generates significant costs in the manufacturing process since it requires a large capital investment. Given the drawbacks of organic-based slurries, the use of water-based slurries which utilize less expensive and more environmentally-friendly solvents, such as aqueous solvents (most commonly water) are preferred in the present invention. These aqueous solvents are remarkably safer and easier to handle than NMP and do not require the implementation of a recovery system.

However, there are problems associated with the use of water-based slurries in the manufacture of lithium-ion batteries. In particular, the electrode active material may react with water to create undesirable effects on the current collector. The complications are particularly noticeable when nickel-containing cathode active materials, such as lithium nickel-manganese-cobalt oxides (NMC), are used as they react strongly with water to form a basic solution. Consequently, when the nickel-containing water-based slurry is coated onto a current collector to form a cathode, the basicity of the slurry would likely corrode the current collector. This problem strongly discourages the use of nickel-containing cathode active materials in water-based manufacturing of batteries, despite the high specific capacities of such active materials.

In addition, several other issues affect the current collector in existing lithium-ion battery technology. A typical electrode comprises a current collector and an electrode layer located on one side or both sides of the current collector; an electrode layer-current collector interface exists where the electrode layer comes into contact with the current collector. This interface acts as a source of electrical resistance for electrons traveling between the electrode layer and the current collector. The interfacial resistance between the electrode layer and the current collector in battery electrodes greatly contributes to the overall internal resistance of the battery, which in turn leads to poor battery electrochemical performance.

In order to improve battery performance, attempts have been made to mitigate the damage done to the current collector or to reduce the interfacial resistance between electrode layer and current collector in battery electrodes.

US Patent Application Publication No. 20130295458 A1 discloses a current collector comprising a metal foil and a layer comprising electrically conductive particles, a binding agent and an organic acid; wherein the layer is provided on one or both surfaces of the metal foil. Polysaccharides and derivatives thereof are preferably used as the binding agent owing to their excellent adhesion to a metal foil and high ionic permeability. The presence of the organic acid allows the electrically conductive particles to be more firmly attached onto the metal foil. With such a configuration, it is believed that the internal resistance and impedance of an electrochemical element comprising said current collector could be reduced. However, the organic acid within the layer would likely cause corrosion of the underlying metal foil over time.

With regard to battery performance, the solid-electrolyte interphase (SEI) is another factor to focus on. After cathodes and anodes are prepared, a lithium-ion battery can be formed by pairing the cathodes and anodes and placing them in contact with an electrolyte. Upon initial charging of the battery, a passivating SEI builds up at the interface between the electrolyte and the anode. The SEI is mainly formed from decomposition products of the electrolyte. Such decomposition consumes lithium ions originating from the cathode, rendering the ions unusable in the normal operations of the battery, so the formation of the SEI gives rise to an irreversible capacity loss of the battery. In practice, for anode active materials such as carbon, between 5% and 20% of the initial capacity is lost in irreversible SEI formation. For anode active materials that undergo a large volume change during battery operation, more lithium ions are consumed for SEI formation. This is the case for silicon, where 20% to 40% of the initial capacity is expended in the formation of the SET. However, the SEI, which is permeable to lithium ions, is of crucial importance to the battery as the presence of the SEI prevents further undesirable decomposition of electrolyte.

In view of such a problem, attempts have been made to mitigate or compensate for this loss of lithium ions to increase or maximize the reversible capacity of lithium-ion batteries. CN Patent Application Publication No. 104037418 A discloses a cathode for a lithium-ion battery, wherein the electrode layer of the cathode is prepared via an electrode slurry which comprises a lithium-containing transition metal oxide cathode active material, a conductive agent, a binder, and a lithium-ion replenishing agent to compensate for the irreversible capacity loss. However, an organic solvent, such as NMP, is preferred as the solvent for the slurry. This means that the drawbacks of using an organic solvent, such as the toxicity of NMP and the requirement to have an NMP recovery system in place, would still remain.

More importantly, the replacement of the lithium ions consumed in SEI formation is achieved by the decomposition of the lithium-ion replenishing agent, during the process of which lithium ions are released. However, the decomposition may also form various gaseous products. If the lithium-ion replenishing agent is situated in the electrode layer, the gaseous products may increase the porosity of the electrode layer and in turn decrease the number of conduction paths available for electrons between the electrode layer and the current collector. This ultimately leads to increased electrode resistance, limiting the effectiveness of the lithium-ion replenishing agent in improving battery performance. Furthermore, if the decomposition of the lithium-ion replenishing agent into gaseous products is not complete, side products may be formed, which would remain as dead weight in the cathode electrode layer that reduces the specific capacity of the battery. The side products could even interfere with the normal operation of the battery, resulting in worsened battery performance overall.

While using water as the solvent of the slurry instead can remove the disadvantages of NMP, changing the solvent alone cannot solve the above-mentioned undesirable effects of using a lithium-ion replenishing agent in the electrode layer to reduce lithium ion loss from SEI formation. Furthermore, as explained above, there would also be the additional issue of lithium loss from dissolution of the cathode active material into water. For that reason, batteries comprising cathodes produced via such a water-based electrode slurry would have poorer reversible capacities than batteries comprising cathodes produced via a conventional organic solvent-based electrode slurry.

Thus, there is also a need to develop a means of compensating for lithium ion loss, particularly in cathodes produced via water-based electrode slurries, in order to effectively reduce the irreversible capacity loss in lithium-ion batteries due to SEI formation during initial charging.

It is worth noting that the above problems are not particular to lithium-ion batteries. Other types of batteries, such as sodium-ion batteries, may also encounter similar problems. Accordingly, it is an aim of the present invention to present a modified current collector to be used in battery cathodes, where the modified current collector is less susceptible to the above-mentioned issues and the electrochemical performance of any battery comprising such a cathode can be enhanced.

### SUMMARY OF THE INVENTION

The aforementioned needs are met by various aspects and embodiments disclosed herein. In one aspect, provided herein is a modified current collector for a cathode of a secondary battery, comprising a substrate and a conductive layer applied on one side or both sides of the substrate, wherein the conductive layer comprises a conductive material, a metal compound, and a binder material, wherein the metal compound can be represented by formula (1):

[A⁺]ₐB^{a-} (1)

wherein cation A⁺ is Li⁺ or Na⁺, a is an integer from 1 to 10, and anion B^{a-} is an inorganic or organic anion. In certain embodiments, the conductive layer further comprises a particulate material.

In some embodiments, the binder material comprises a copolymer comprising a structural unit (a), wherein the structural unit (a) comprises one or more monomeric unit(s) with formula (2):

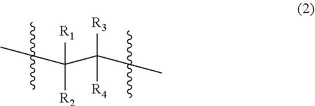

and wherein each of R₁, R₂, R₃ and R₄ in formula (2) is independently H, hydroxyl, alkyl or hydroxyalkyl.

In some embodiments, the copolymer further comprises a structural unit (b), wherein the structural unit (b) comprises one or more monomeric unit(s) with formula (3):

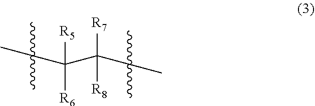

and wherein each of R₅, R₆, R₇ and R₈ in formula (3) is independently H, alkyl, acyloxy or acyloxyalkyl.

In another aspect, provided herein is a cathode, comprising the modified current collector and an electrode layer located on the surface of the conductive layer, and wherein the electrode layer comprises a cathode active material and a binding agent.

The invention as disclosed herein solves the above-mentioned problems that affect batteries. Firstly, the conductive layer of the modified current collector can act as a physical barrier between the substrate and the alkaline cathode active material in the electrode layer. This prevents the corrosion of the substrate without compromising the conductivity within the cathode.

Secondly, the metal compound in the conductive layer of the modified current collector compensates for metal ion loss and reduces the irreversible capacity loss in initial battery charging.

Thirdly, the conductive material in the conductive layer of the modified current collector reduces the interfacial resistance between the electrode layer and the modified current collector itself, which improves the output performance of the cathode.

Furthermore, when a water-based cathode slurry is applied on the conductive layer of the modified current collector to form the electrode layer, there is a risk that the conductive layer would revert to a fluid by dissolving into the cathode slurry. This could lead to delamination of the conductive layer. The conductive layer of the modified current collector disclosed herein has excellent adhesion to the substrate due to the effect of the binder material (and the particulate material if present) in the layer, and thus the mechanical strength of the cathode is improved, such that delamination of the layer is prevented.

As a result of the above advantages, batteries comprising cathodes that are produced using a modified current collector of the present invention exhibit exceptional electrochemical performance.

### BRIEF DESCRIPTION OF THE DRAWINGS

FIGS. 1a and 1b show the simplified views of two different embodiments of the modified current collector disclosed herein within a cathode.

### DETAILED DESCRIPTION OF THE INVENTION

In one aspect, provided herein is a modified current collector in a cathode for a battery, wherein the modified current collector comprises a substrate and a conductive layer located on one side or both sides of the substrate. The conductive layer itself comprises a binder material, a conductive material, and a metal compound, wherein the binder material comprises a suitable copolymer, and wherein the conductive layer may additionally comprise a particulate material. The conductive layer can be produced by coating a conductive slurry on the substrate, wherein the conductive slurry comprises the materials to be used to form the conductive layer, as well as an aqueous solvent. In another aspect, provided herein is a cathode, comprising the modified current collector and an electrode layer located on top of the modified current collector, wherein the electrode layer comprises a cathode active material and a binding agent, and may additionally comprise a conductive agent. The electrode layer can be produced by coating a cathode slurry onto the modified current collector of the present invention, wherein the cathode slurry comprises the cathode active material, the binding agent, and an aqueous solvent (and optionally, the conductive agent).

The term “electrode” refers to a “cathode” or an “anode.”

The term “electrode component” refers to any substance that is present in an electrode layer of an electrode, including but not limited to electrode active materials, conductive agents, and binding agents.

The term “positive electrode” is used interchangeably with cathode. Likewise, the term “negative electrode” is used interchangeably with anode.

The term “binder”, “binder material” or “binding agent” refers to a chemical compound, a mixture of compounds or a polymer that is used to hold material(s) in place and adhere them onto a surface. In some embodiments, the binder material refers to a chemical compound, mixture of compounds, or polymer that is used to hold a conductive material in place and adhere it onto a substrate to form a modified current collector. In some embodiments, the binding agent refers to a chemical compound, mixture of compounds, or polymer that is used to hold an electrode material and/or a conductive agent in place and adhere them onto a modified current collector to form an electrode. In some embodiments, the electrode does not comprise any conductive material or conductive agent. In some embodiments, each of the binder material and the binding agent independently forms a colloid in an aqueous solvent such as water. In some embodiments, each of the binder material and the binding agent independently forms a solution or dispersion in an aqueous solvent such as water.

The term “conductive material” or “conductive agent” refers to a material that has good electrical conductivity. Therefore, a conductive material is often added in the making of a modified current collector to improve its electrical conductivity. In some embodiments, a conductive agent is mixed with an electrode active material at the time of forming an electrode to improve electrical conductivity of the electrode. In some embodiments, each of the conductive material and the conductive agent is independently chemically active. In some embodiments, each of the conductive material and the conductive agent is independently chemically inactive.

The term “polymer” refers to a compound prepared by polymerizing monomers, whether of the same type or of different types. The generic term “polymer” embraces the terms “homopolymer” and “copolymer”.

The term “homopolymer” refers to a polymer prepared by the polymerization of the same type of monomer.

The term “copolymer” refers to a polymer prepared by the polymerization of two or more different types of monomers.

The term “particulate material” refers to a substance in the form of particles. Said particles can be in the form of primary particles, secondary particles, tertiary particles, or a combination thereof. The term “primary particle” refers to an independently existing particle which is not composed of an aggregate. The term “secondary particle” refers to an aggregate particle formed by agglomeration of primary particles, and the term “tertiary particle” refers to an aggregate particle formed by agglomeration of secondary particles.

The term “aqueous solvent” refers to a solution containing water as the major component and one or more minor components in addition to water, or a solution that consists solely of water.

With respect to a slurry, the term “water-based” means that the solvent of the slurry is an aqueous solvent. With respect to a mode of manufacturing electrodes or batteries, the term “water-based” means that at least one element of the electrode or battery is wholly or partially formed using an aqueous slurry.

The term “unsaturated” refers to a moiety having one or more units of unsaturation.

The term “alkyl” or “alkyl group” refers to a univalent group having the general formula CₙH₂ₙ₊₁ derived from removing a hydrogen atom from a saturated, unbranched or branched aliphatic hydrocarbon, where n is an integer.

The term “cycloalkyl” or “cycloalkyl group” refers to a saturated or unsaturated cyclic non-aromatic hydrocarbon radical having a single ring or multiple condensed rings. Examples of cycloalkyl groups include, but are not limited to, cyclopropyl, cyclobutyl, cyclopentyl, cyclohexyl, cycloheptyl, cyclopropenyl, cyclobutenyl, cyclopentenyl, cyclohexenyl, cycloheptenyl, and cyclic and bicyclic terpenes. A cycloalkyl group can be unsubstituted or substituted by one or two suitable substituents. Furthermore, the cycloalkyl group can be monocyclic or polycyclic.

The term “alkenyl” refers to a univalent group derived from the removal of a hydrogen atom from any carbon atom of an unsaturated aliphatic hydrocarbon with at least one carbon-carbon double bond. Similarly, the term “alkynyl” refers to a univalent group derived from the removal of a hydrogen atom from any carbon atom of an unsaturated aliphatic hydrocarbon with at least one carbon-carbon triple bond. Furthermore, the term “enynyl” refers to a univalent group derived from the removal of a hydrogen atom from any carbon atom of an unsaturated aliphatic hydrocarbon with at least one carbon-carbon double bond and at least one carbon-carbon triple bond. The unsaturated aliphatic hydrocarbon of an alkenyl, alkynyl or enynyl may be branched or unbranched.

The term “alkoxy” refers to an alkyl group attached to the principal carbon chain through an oxygen atom. Some non-limiting examples of the alkoxy group include methoxy, ethoxy, propoxy, butoxy, and the like. An alkoxy group may be substituted or unsubstituted.

The term “alkylene” refers to a saturated divalent hydrocarbon group derived from the removal of two hydrogen atoms from a branched or unbranched saturated hydrocarbon. Examples of an alkylene group include methylene (—CH₂—), ethylene (—CH₂CH₂—), isopropylene (—CH(CH₃)CH₂—), and the like. The alkylene group is optionally substituted with one or more substituents.

The term “aryl” or “aryl group” refers to an organic radical derived from a monocyclic or polycyclic aromatic hydrocarbon by removing a hydrogen atom. Non-limiting examples of an aryl group include phenyl, naphthyl, benzyl, tolanyl, sexiphenyl, phenanthrenyl, anthracenyl, coronenyl, and tolanylphenyl. An aryl group can be unsubstituted or substituted with one or more suitable substituents. Furthermore, the aryl group can be monocyclic or polycyclic.

The term “alkylamino” refers to a group derived from the removal of a hydrogen atom from a primary or secondary amine. Alkylamino embraces the terms “N-alkylamino” and “N,N-dialkylamino”, wherein the amino group is independently substituted with one or two alkyl groups, respectively. The alkylamino group is optionally substituted with one or more substituents.

The term “alkylthio” refers to a group containing a branched or unbranched alkyl group attached to a divalent sulfur atom. Some non-limiting examples of the alkylthio group include methylthio (CH₃S—). The alkylthio group is optionally substituted with one or more substituents.

The term “heteroatom” refers to one or more of oxygen (O), sulfur (S), nitrogen (N), phosphorus (P) or silicon (Si), including any oxidized form of nitrogen (N), sulfur (S) or phosphorus (P); the quaternized form of any basic nitrogen; or a substitutable nitrogen of a heterocyclic ring, for example N (as in 3,4-dihydro-2H-pyrrolyl), NH (as in pyrrolidinyl) or NR (as in N-substituted pyrrolidinyl).

The term “carbonyl” refers to —(C═O)—.

The term “acyl” refers to —(C═O)—Z, wherein Z is an alkyl.

The term “acyloxy” refers to —O—(C═O)—Z, wherein Z is an alkyl.

The term “acyloxyalkyl” refers to —Y—O—(C═O)—Z, wherein Z is an alkyl and Y is an alkylene.

The term “hydroxyalkyl” refers to —Y—O—H, wherein Y is alkylene. Therefore, hydroxyalkyl consists of hydroxyl bonded to alkylene.

The term “amido” refers to —NH(C═O)—R.

The term “aliphatic” refers to a non-aromatic hydrocarbon or groups derived therefrom. Some non-limiting examples of aliphatic compounds include alkanes, alkenes, alkynes, alkyl groups, alkenyl groups, alkynyl groups, alkylene groups, alkenylene groups, or alkynylene groups.

The term “aromatic” refers to groups comprising aromatic hydrocarbon rings, optionally including heteroatoms or substituents. Examples of such groups include, but are not limited to, phenyl, tolyl, biphenyl, o-terphenyl, m-terphenyl, p-terphenyl, naphthyl, anthryl, phenanthryl, pyrenyl, triphenylenyl, and derivatives thereof.

The term “substituted” is used to describe a compound or chemical moiety wherein at least one hydrogen atom of that compound or chemical moiety is replaced with a second chemical moiety. Examples of substituents include, but are not limited to, halogen; alkyl; heteroalkyl; alkenyl; alkynyl; enynyl; aryl, heteroaryl, hydroxyl; alkoxyl; amino; nitro; thiol; alkylthio; imine; cyano; amido; phosphonato; phosphinato; carboxyl; thiocarbonyl; sulfonyl; sulfonamide; acyl; formyl; acyloxy; alkoxycarbonyl; oxo; haloalkyl (e.g., trifluoromethyl); carbocyclic cycloalkyl, which can be monocyclic or fused or non-fused polycyclic (e.g., cyclopropyl, cyclobutyl, cyclopentyl or cyclohexyl) or a heterocycloalkyl, which can be monocyclic or fused or non-fused polycyclic (e.g., pyrrolidinyl, piperidinyl, piperazinyl, morpholinyl or thiazinyl); carbocyclic or heterocyclic aryl, which can be monocyclic or fused or non-fused polycyclic (e.g., phenyl, naphthyl, pyrrolyl, indolyl, furanyl, thiophenyl, imidazolyl, oxazolyl, isoxazolyl, thiazolyl, triazolyl, tetrazolyl, pyrazolyl, pyridinyl, quinolinyl, isoquinolinyl, acridinyl, pyrazinyl, pyridazinyl, pyrimidinyl, benzimidazolyl, benzothiophenyl or benzofuranyl); amino, monoalkylamino and dialkylamino; o-lower alkyl; o-aryl, aryl; aryl-lower alkyl; —CO₂CH₃; —CONH₂; —OCH₂CONH₂; —NH₂; —SO₂NH₂; —OCHF₂; —CF₃; —OCF₃; —NH(alkyl); —N(alkyl)₂; —NH(aryl); —N(alkyl)(aryl); —N(aryl)₂; —CHO; —CO(alkyl); —CO(aryl); —CO₂(alkyl); and —CO₂(aryl); and such moieties can also be optionally substituted by a fused-ring structure or bridge, for example —OCH₂O—. These substituents can optionally be further substituted with one or more substituents. All chemical groups disclosed herein can be substituted, unless specified otherwise.

The term “straight-chain” refers to an organic compound or a moiety that does not comprise a side chain or a cyclic structure; i.e., the carbon atoms of the organic compound or moiety all form a single linear arrangement. A straight-chain compound or moiety can be substituted or unsubstituted, as well as saturated or unsaturated.

The term “halogen” or “halo” refers to F, Cl, Br or I.

The term “monomeric unit” refers to the constitutional unit derived from a single monomer to the structure of a polymer.

The term “structural unit” refers to the total monomeric units derived from the same monomer type in a polymer.

The term “homogenizer” refers to an equipment that can be used to homogenize materials, i.e., to distribute materials uniformly throughout a fluid. Where homogenization is disclosed herein, any conventional homogenizer can be used for the homogenization process. Some non-limiting examples of homogenizers include stirring mixers, planetary stirring mixers, blenders and ultrasonicators.

The term “applying” refers to an act of laying or spreading a substance on a surface.

The term “current collector” refers to any conductive substrate, which is capable of conducting an electrical current flowing to electrodes during discharging or charging a secondary battery. Some non-limiting examples of a current collector include a single metal layer or single substrate, and a single metal layer or single substrate with an overlying conductive layer, such as a carbon black-based conductive layer. In some embodiments, the current collector may be in contact with an electrode layer.

The term “modified current collector” refers to a substrate with a conductive layer applied on one side or both sides of the substrate.

The term “electrode layer” refers to a layer that comprises an electrochemically active material. In some embodiments, the electrode layer is in contact with a current collector, a modified current collector or a substrate. In some embodiments, the electrode layer is made by applying a coating on to a current collector, a modified current collector or a substrate and drying the coating. In some embodiments, the electrode layer is located on the surface of the current collector or the modified current collector. In other embodiments, a three-dimensional porous current collector or modified current collector is coated conformally with an electrode layer.

The term “room temperature” refers to indoor temperatures from about 18° C. to about 30° C., e.g., 18, 19, 20, 21, 22, 23, 24, 25, 26, 27, 28, 29, or 30° C. In some embodiments, room temperature refers to a temperature of about 20° C.+/−1° C. or +/−2° C. or +/−3° C. In other embodiments, room temperature refers to a temperature of about 22° C. or about 25° C.

The term “solid content” refers to the amount of non-volatile material remaining after evaporation.

The term “peeling strength” refers to the amount of force required to separate two materials that are adhered to each other, such as a current collector and an electrode layer. It is a measure of the binding strength between such two materials and is usually expressed in N/cm.

The term “adhesive strength” refers to the amount of force required to separate a substrate and a binder material adhered to the substrate. It is a measure of the adhesive performance of the binder material towards the substrate and is usually expressed in N/cm.

The term “C rate” refers to the charging or discharging rate of a cell or battery, expressed in terms of its total storage capacity in Ah or mAh. For example, a rate of 1 C means utilization of all of the stored energy in one hour; 0.1 C means utilization of 10% of the energy in one hour or full energy in 10 hours; and 5 C means utilization of full energy in 12 minutes.

The term “ampere-hour (Ah)” refers to a unit used in specifying the storage capacity of a battery. For example, a battery with 1 Ah capacity can supply a current of one ampere for one hour or 0.5 A for two hours, etc. Therefore, 1 ampere-hour (Ah) is the equivalent of 3,600 coulombs of electrical charge. Similarly, the term “milliampere-hour (mAh)” also refers to a unit of the storage capacity of a battery and is 1/1,000 of an ampere-hour.

The term “battery cycle life” refers to the number of complete charge/discharge cycles a battery can perform before its nominal capacity falls below 80% of its initial rated capacity.

The term “capacity” is a characteristic of an electrochemical cell that refers to the total amount of electrical charge an electrochemical cell, such as a battery, is able to hold. Capacity is typically expressed in units of ampere-hours. The term “specific capacity” refers to the capacity output of an electrochemical cell, such as a battery, per unit weight, usually expressed in Ah/kg or mAh/g.

In the following description, all numbers disclosed herein are approximate values, regardless of whether the word “about” or “approximate” is used in connection therewith. They may vary by 1 percent, 2 percent, 5 percent, or, sometimes, 10 to 20 percent. Whenever a numerical range with a lower limit, R^{L}, and an upper limit, Ru, is disclosed, any number falling within the range is specifically disclosed. In particular, the following numbers within the range are specifically disclosed: R=R^{L}+k*(R^{U}−R^{L}), wherein k is a variable ranging from 0 percent to 100 percent. Moreover, any numerical range defined by two R numbers as defined above is also specifically disclosed.

In the present description, all references to the singular include references to the plural and vice versa.

Battery electrodes commonly comprise a current collector and an electrode layer located on one side or both sides of the current collector. Typically, the electrode is prepared by dispersing an electrode active material and a binding agent in a solvent to form an electrode slurry, then coating the electrode slurry onto a current collector and drying it to form the electrode layer. Said electrode slurry (and hence, the resultant electrode layer) may additionally comprise conductive carbon. Regardless of the components present in the electrode layer, the discontinuity between the electrode layer and the current collector of the electrode means that significant interfacial resistance exists between the electrode layer and the current collector. Batteries comprising such electrodes would then have suboptimal electrochemical performances as a result of such interfacial resistances.

Among batteries, lithium-ion batteries are some of the most widely researched and used. A common electrode slurry composition for lithium-ion batteries comprises PVDF as a binding agent and NMP as a solvent, but the use of NMP presents significant environmental, health and safety risks, in addition to incurring additional costs associated with a recovery system. Therefore, water-based electrode slurries comprising an aqueous solvent, such as water, have been proposed as an alternative. Lithium-ion batteries that comprise electrodes produced using such electrode slurries have excellent battery performance, and the electrode production process has reduced environmental, health and safety risks.

However, corrosion of current collectors is particularly pronounced in cathodes produced using a water-based slurry that comprises a nickel-containing cathode active material, such as NMC, since such a slurry would be quite basic.

In lithium-ion batteries, lithium intercalation/deintercalation in the anode usually takes place at low potentials vs. Li/Li⁺, where non-aqueous liquid electrolytes are thermodynamically unstable. During initial charging, electrolyte decomposition inevitably occurs in an irreversible manner, leading to the formation of a solid-electrolyte interphase (SEI) over the anode surface. This is beneficial in the sense that the SEI generated can suppress further electrolyte decomposition to give a satisfactory battery cycling performance. The SEI formation is not, however, favorable with respect to the specific capacity of lithium-ion batteries, since a portion of the cathode active material is irreversibly consumed to provide lithium ions for SEI formation on the anode.

A proposed solution to irreversible capacity loss due to the formation of the SEI in lithium-ion batteries is the addition of a lithium-ion replenishing agent to the electrode layer of the cathode. This lithium-ion replenishing agent would decompose during initial charging in order to release lithium ions, which would be consumed in the formation of the SET. However, various gaseous products would also be released as a result, increasing the porosity of the cathode electrode layer. This in turn leads to increased electrode resistance, hence limiting the actual improvement in battery performance the lithium-ion replenishing agent can provide. Furthermore, if the decomposition of the lithium-ion replenishing agent is not complete, the side products formed may lead to worsened battery performance.

In addition, when a water-based cathode slurry is used to manufacture the electrode layer of a cathode of a lithium-ion battery, an additional obstacle is present in that lithium has a tendency to leach out of the cathode active material in the preparation of the cathode slurry. As a result, a battery containing such a cathode would have a comparatively lower reversible capacity than a battery containing a cathode prepared with a conventional cathode slurry that uses an organic solvent.

To solve the aforementioned problems, inventors of the present invention have proposed the use of a novel modified current collector, comprising a substrate and a conductive layer located on one side or both sides of the substrate. In a battery cathode, the conductive layer of the modified current collector disclosed herein reduces interfacial resistance between the electrode layer and the modified current collector and acts as a physical barrier between the substrate and the cathode electrode layer, which helps alleviate the corrosion tendency of the substrate. The conductive layer of the present invention also has the advantage of not being easily dissolved by the water-based cathode slurry coated thereon and reverting to a fluid, and in addition is able to compensate for metal ion loss due to formation of the SEI.

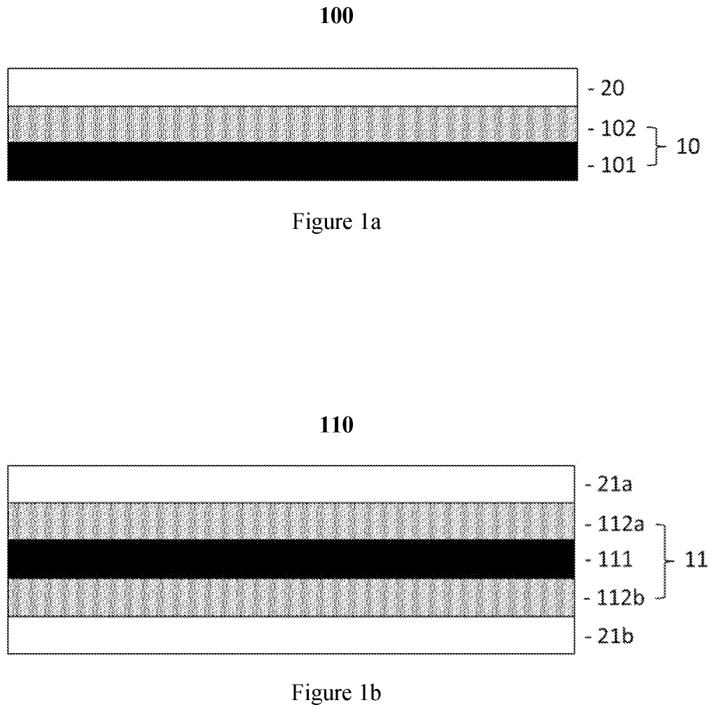

The modified current collector as described herein refers to a substrate with a conductive layer applied on one side or both sides of the substrate, wherein the conductive layer comprises a conductive material, a metal compound, and a binder material, and may additionally comprise a particulate material. FIG. 1a shows a simplified view of an embodiment of the modified current collector of the present invention, represented by 10, within an electrode 100. The modified current collector 10 comprises a substrate 101 with a conductive layer 102 applied on one side of the substrate 101. In battery cathode production, an electrode layer 20 may be located on the surface of the conductive layer 102.

FIG. 1b shows a simplified view of another embodiment of the modified current collector of the present invention, represented by 11, within an electrode 110. The modified current collector 11 comprises a substrate 111 with conductive layers 112a and 112b applied on both sides of the substrate 111. In the process of manufacturing a battery cathode, electrode layers 21a and 21b could be applied on the surface of the conductive layers 112a and 112b respectively.

When applied in a battery system, the substrate within the modified current collector of the present invention specifically acts to collect electrons generated by electrochemical reactions of the cathode active material or to supply electrons required for the electrochemical reactions.

In some embodiments, the substrate may be in the form of a foil, sheet, film or porous body with a three-dimensional network structure. In some embodiments, the substrate may be made of a polymeric or metallic material or a metalized polymer. In some embodiments, the substrate is covered with a conformal carbon layer. In some embodiments, the substrate is made of a single material. In other embodiments, the substrate is made of more than one material.

In some embodiments, the substrate is a metal. In some embodiments, the substrate has a single-layer structure. In some embodiments, the substrate is selected from the group consisting of stainless steel, titanium, nickel, aluminum, copper, platinum, gold, silver, chromium, zirconium, tungsten, molybdenum, silicon, tin, vanadium, zinc, cadmium, alloys thereof, electrically-conductive resin, and combinations thereof.

In certain embodiments, the substrate has a two-layered structure comprising an outer layer and an inner layer, wherein the outer layer comprises a conductive additive and the inner layer comprises an insulating material or another conductive additive; for example, aluminum mounted with a conductive resin layer or a polymeric insulating material coated with an aluminum layer. In some embodiments, the conductive additive is selected from the group consisting of stainless steel, titanium, nickel, aluminum, copper, platinum, gold, silver, chromium, zirconium, tungsten, molybdenum, silicon, tin, vanadium, zinc, cadmium, alloys thereof, electrically-conductive resin, and combinations thereof.

In some embodiments, the substrate has a three-layered structure comprising an outer layer, a middle layer, and an inner layer, wherein the outer and inner layers comprise a conductive additive, and the middle layer comprises an insulating material or another conductive additive; for example, plastic coated with a metal film on both sides. In certain embodiments, each of the outer layer, middle layer and inner layer is independently selected from the group consisting of stainless steel, titanium, nickel, aluminum, copper, platinum, gold, silver, chromium, zirconium, tungsten, molybdenum, silicon, tin, vanadium, zinc, cadmium, alloys thereof, electrically-conductive resin, and combinations thereof.

In some embodiments, the insulating material is a polymeric material selected from the group consisting of polycarbonate, polyacrylate, polyacrylonitrile, polyester, polyamide, polystyrene, polyurethane, polyepoxy, poly(acrylonitrile butadiene styrene), polyimide, polyolefin, polyethylene, polypropylene, polyphenylene sulfide, poly(vinyl ester), polyvinyl chloride, polyether, polyphenylene oxide, cellulose polymer, and combinations thereof. In certain embodiments, the substrate has more than three layers.

In some embodiments, the conductive layer comprises a conductive material, a metal compound, and a binder material. In some embodiments, the conductive layer additionally comprises a particulate material. In certain embodiments, the conductive layer further comprises a surfactant or dispersing agent.

In a battery cathode comprising the modified current collector of the present invention and an electrode layer, the conductive material in the conductive layer of the modified current collector provides conductive pathways for electrons in travelling in-between the electrode layer and the substrate of the modified current collector. This significantly reduces the interfacial resistance between the electrode layer and the modified current collector, i.e., at the electrode layer-modified current collector interface.

In some embodiments, the conductive material in the conductive layer is selected from the group consisting of natural graphite particulate, synthetic graphite particulate, hard carbon, soft carbon, mesocarbon microbeads (MCMB), carbon black, graphite, expanded graphite, graphene, graphene nanoplatelets, carbon fibers, carbon nano-fibers, graphitized carbon flake, carbon tubes, carbon nanotubes, activated carbon, Super P, KS6, vapor grown carbon fibers (VGCF), mesoporous carbon, and combinations thereof.

In a cathode comprising a modified current collector of the present invention, the metal compound in the conductive layer of the modified current collector is the source of metal ions that would compensate for metal ions lost to the formation of the SEI. As noted above, the state of the art provides solutions wherein the metal compound that releases the compensatory metal ions is located in the cathode electrode layer. However, gaseous products are also produced during the release of the compensatory metal ions, and such gaseous products increase the porosity of the electrode layer and hence the electrode resistance. Incomplete decomposition of the metal compound may also produce side products in the electrode later that could interfere with battery operation. Deposits of side products on the surface of cathode active material may block the diffusion pathway of Li ions. However, by placing the metal compound in the conductive layer instead of the electrode layer, a modified current collector of the present invention prevents the above-mentioned issues from occurring and provides a mechanism for metal ions compensation without drawbacks to the performance of the resultant electrode or battery. Accordingly, the presence of the metal compound specifically in the conductive layer of the modified current collector is critical to improving the performance of a battery comprising the modified current collector of the present invention.

In some embodiments, the metal compound is a compound represented by formula (1):

[A⁺]ₐB^{a-} (1)

In some embodiments, cation A⁺ is selected from the group consisting of Li⁺, Na⁺, and combinations thereof. When the modified current collector of the present invention is used to produce a cathode of a lithium-ion battery, it is preferable for cation A⁺ to be Li⁺, in order to ensure that no side reactions which could affect battery performance could occur. Similarly, when the modified current collector of the present invention is used to produce a cathode of a sodium-ion battery, it is therefore preferable for cation A⁺ to be Na⁺.

In some embodiments, a is an integer from 1 to 10. In some embodiments, a is 1, 2, 3, 4, 5, 6, 7, 8, 9, or 10.

There are no particular limitations to the choice of anion B^{a-}, except that a salt comprising such an anion should not react with water or other compounds that could be present in the solvent of the conductive slurry, so as to prevent the formation of undesirable side products that could affect the performance of the resultant cathode or battery. Thus, it is not preferable for anion B^{a-} to be, for example, O²⁻, O₂²⁻, S²⁻, or N³⁻ since such anions react readily with water. In addition, a salt comprising anion B^{a-} should not form an alkaline solution when dissolved in the solvent of the conductive slurry, as the alkalinity would corrode the substrate underneath the conductive layer of the modified current collector. Accordingly, it is also not preferable for anion B^{a-} to be, for example, OH⁻, which is highly alkaline. In some embodiments, anion B^{a-} is an organic anion. In other embodiments, anion B^{a-} is not an organic anion. In certain embodiments, anion B^{a-} is an organic anion comprising one or more carboxylate or carboxylic acid groups.

In certain embodiments, anion B^{a-} is an inorganic anion selected from the group consisting of azide, nitrite, chloride, bromide, iodide, borate, metaborate, fluoroborate, perchlorate and combinations thereof.

In some embodiments, anion B^{a-} is an organic anion selected from the group consisting of deltate, squarate, croconate, rhodizonate, bis(trifluoromethanesulfonyl)imide, bis(fluorosulfonyl)imide, difluoro(oxalato)borate, and bis(oxalato)borate, and combinations thereof.

In certain embodiments, anion B^{a-} is an organic anion selected from the group consisting of formate, acetate, propionate, butyrate, pentanoate, oxalate, malonate, succinate, glutarate, adipate, pimelate, hydrogenoxalate, hydrogenmalonate, hydrogensuccinate, hydrogenglutarate, hydrogenadipate, hydrogenpimelate, citrate, hydrogencitrate, dihydrogencitrate, lactate, ketomalonate, ketosuccinate, hydrogenketomalonate, hydrogenketosuccinate, 3,4-dihydroxybenzoate, 3,4-dihydroxybutyrate, isomers thereof, and combinations thereof.

In a battery cathode comprising the modified current collector of the present invention and an electrode layer, the binder material in the conductive layer of the modified current collector provides adhesion of component(s) within the conductive layer to one another, as well as to the substrate. Since the conductive layer is usually produced with an aqueous slurry, it is preferable for the binder material to be sufficiently hydrophilic so it can be well dispersed in an aqueous solvent. Such a binder material would ensure that the aqueous slurry can be handled and processed easily, and that the resultant conductive layer is homogeneous and smooth, without local unevenness that could affect the performance of the cathode. Therefore, conventional binder materials that are highly hydrophobic (such as PVDF) are not suitable as the binder material in the conductive layer of a modified current collector of the present invention.

At the same time, it is also preferable for the binder material to be sufficiently hydrophobic such that a conductive layer comprising said binder material does not revert to a fluid upon contact with the aqueous solvent of a water-based cathode slurry. Accordingly, conventional binder materials that are highly hydrophilic (such as CMC or PAA) are also not suitable as the binder material in the conductive layer of a modified current collector of the present invention. Therefore, the binder material in the conductive layer of a modified current collector of the present invention should not only have good binding performance, but also have a good balance of hydrophilic and hydrophobic properties.

In some embodiments, the binder material in the conductive layer comprises a copolymer. In some embodiments, the copolymer comprises a structural unit (a) and a structural unit (b). In some embodiments, structural unit (a) constitutes the hydrophilic portion of the copolymer. In some embodiments, structural unit (b) constitutes the hydrophobic portion of the copolymer.

In some embodiments, the structural unit (a) in the copolymer of the binder material comprises one or more monomeric unit(s) with formula (2):

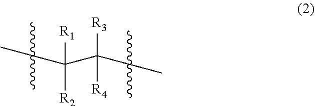

In some embodiments, each of R₁, R₂, R₃ and R₄ in formula (2) is independently H, hydroxyl, alkyl, hydroxyalkyl, halogen or alkyl halide. In certain embodiments, at least one of R₁, R₂, R₃ and R₄ is hydroxyl or hydroxyalkyl. In some embodiments, at least two of R₁, R₂, R₃ and R₄ are the same. In other embodiments, each of R₁, R₂, R₃ and R₄ differ from one another.

In some embodiments, an alkyl group has a general formula CₙH₂ₙ₊₁, where n is an integer between 1 and 40, between 1 and 20 or between 1 and 8. In some embodiments, the alkyl group can be selected from the group consisting of C₁-C₄₀ alkyl group, C₁-C₃₀ alkyl group, C₁-C₂₀ alkyl group, C₁-C₁₀ alkyl group, C₅-C₄₀ alkyl group, C₅-C₃₀ alkyl group, C₅-C₂₀ alkyl group, C₅-C₁₀ alkyl group, C₁₀-C₄₀ alkyl group, C₁₀-C₃₀ alkyl group and C₁₀-C₂₀ alkyl group.

Examples of alkyl groups include, but are not limited to, C₁-C₈ alkyl groups, such as methyl, ethyl, propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, pentyl, isopentyl, neopentyl, hexyl, heptyl and octyl. Longer alkyl groups include nonyl and decyl groups. An alkyl group can be unsubstituted or substituted with one or more suitable substituents. Furthermore, the alkyl group can be branched or unbranched. In some embodiments, the alkyl group contains at least 2, 3, 4, 5, 6, 7, or 8 carbon atoms.

In some embodiments, the hydroxyalkyl group can be selected from the group consisting of C₁-C₄₀ hydroxyalkyl group, C₁-C₃₀ hydroxyalkyl group, C₁-C₂₀ hydroxyalkyl group, C₁-C₁₀ hydroxyalkyl group, C₅-C₄₀ hydroxyalkyl group, C₅-C₃₀ hydroxyalkyl group, C₅-C₂₀ hydroxyalkyl group, C₅-C₁₀ hydroxyalkyl group, C₁₀-C₄₀ hydroxyalkyl group, C₁₀-C₃₀ hydroxyalkyl group and C₁₀-C₂₀ hydroxyalkyl group.

Examples of hydroxyalkyl groups include, but are not limited to, hydroxymethyl, hydroxyethyl, hydroxypropyl, hydroxy methyl propyl, hydroxy butyl, and hydroxy methyl butyl, hydroxy dimethyl propyl, hydroxy methyl pentyl, hydroxy dimethyl butyl, hydroxy ethyl butyl, hydroxy pentyl, hydroxy neopentyl, hydroxy hexyl, hydroxy heptyl and hydroxy octyl. The alkyl group within hydroxyalkyl group can be branched or unbranched.

In some embodiments, the halogen can be selected from the group consisting of fluorine, chlorine, bromine, iodine, astatine, and combinations thereof.

Some non-limiting examples of alkyl halide include methyl fluoride, methyl chloride, methyl bromide, methyl iodide, methyl astatide, ethyl fluoride, ethyl chloride, ethyl bromide, ethyl iodide, ethyl astatide, propyl fluoride, propyl chloride, propyl bromide, propyl iodide and propyl astatide.

In general, structural unit (a) is hydrophilic in nature. For this reason, it would be improbable for each of R₁, R₂, R₃ and R₄ in formula (2) in the monomeric unit(s) within structural unit (a) to independently comprise a long hydrocarbon chain. The presence of long hydrocarbon chain(s) within the monomeric unit(s) of structure unit (a) would render a loss in hydrophilicity of structural unit (a) in the copolymer. This might potentially affect the overall dispersion of the binder material during the making of the conductive layer, and thus its homogeneity. Not only would this create inconsistencies in adhesivity across the substrate-conductive layer interface, the conductivity network developed to facilitate electrons traveling between the electrode layer and the substrate could also be severely weakened, which would intensify the interfacial resistance between the electrode layer and the modified current collector. In some embodiments, the alkyl group and the hydroxyalkyl group are C₁-C₈ alkyl group and C₁-C₈ hydroxyalkyl group respectively.

Conversely, it is undesirable for each of R₁, R₂, R₃ and R₄ in formula (2) in the monomeric unit(s) within structural unit (a) to independently be a hydroxyl or hydroxyalkyl. Structural unit (a) comprising excessive amounts of hydroxyl or hydroxyalkyl groups might lead to an overabundance of hydrogen bonding interactions between the hydroxyl groups and/or the hydroxyalkyl groups, both within a copolymer chain and between different copolymer chains. As a result, this would induce agglomeration and poor dispersibility of the binder material produced therefrom and other material(s) (e.g., conductive material) within the conductive slurry in the production of the conductive layer. In some embodiments, no more than three of R₁, R₂, R₃ and R₄ in formula (2) is hydroxyl or hydroxyalkyl. In certain embodiments, no more than two of R₁, R₂, R₃ and R₄ in formula (2) is hydroxyl or hydroxyalkyl. In certain embodiments, only one of R₁, R₂, R₃ and R₄ in formula (2) is hydroxyl or hydroxyalkyl. In other embodiments, only one of R₁, R₂, R₃ and R₄ in formula (2) is hydroxyl. In certain embodiments, only one of R₁, R₂, R₃ and R₄ in formula (2) is hydroxyl and the remaining three of each of R₁, R₂, R₃ and R₄ in formula (2) is independently alkyl or H. In further embodiments, only one of R₁, R₂, R₃ and R₄ in formula (2) is hydroxyl and the remaining three of each of R₁, R₂, R₃ and R₄ in formula (2) is independently H.

In some embodiments, the structural unit (b) in the copolymer of the binder material comprises one or more monomeric unit(s) with formula (3):

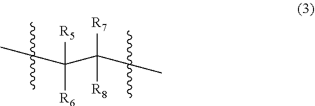

In some embodiments, each of R₅, R₆, R₇ and R₈ in formula (3) is independently H, alkyl, acyloxy, acyloxyalkyl, halogen or alkyl halide. In certain embodiments, at least one of R₅, R₆, R₇, and R₈ is acyloxy or acyloxyalkyl. In some embodiments, at least two of R₅, R₆, R₇ and R₈ are the same. In other embodiments, each of R₅, R₆, R₇ and R₈ differ from one another.

In some embodiments, the alkyl group within each of an acyloxy group or an acyloxyalkyl group can independently be selected from the group consisting of a C₁-C₄₀ alkyl group, C₁-C₃₀ alkyl group, C₁-C₂₀ alkyl group, C₁-C₁₀ alkyl group, C₅-C₄₀ alkyl group, C₅-C₃₀ alkyl group, C₅-C₂₀ alkyl group, C₅-C₁₀ alkyl group, C₁₀-C₄₀ alkyl group, C₁₀-C₃₀ alkyl group and C₁₀-C₂₀ alkyl group.

Examples of the alkyl group within each of an acyloxy group or an acyloxyalkyl group include, but are not limited to, C₁-C₈ alkyl groups, such as methyl, ethyl, propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, pentyl, isopentyl, neopentyl, hexyl, heptyl and octyl. Longer alkyl groups include nonyl and decyl groups. The alkyl group can be unsubstituted or substituted with one or more suitable substituents. Furthermore, the alkyl group can be branched or unbranched. In some embodiments, the alkyl group contains at least 2, 3, 4, 5, 6, 7, or 8 carbon atoms.

In some embodiments, the alkylene group within an acyloxyalkyl group can independently be selected from the group consisting of a C₁-C₄₀ alkylene group, C₁-C₃₀ alkylene group, C₁-C₂₀ alkylene group, C₁-C₁₀ alkylene group, C₅-C₄₀ alkylene group, C₅-C₃₀ alkylene group, C₅-C₂₀ alkylene group, C₅-C₁₀ alkylene group, C₁₀-C₄₀ alkylene group, C₁₀-C₃₀ alkylene group and C₁₀-C₂₀ alkylene group. The alkylene group within the acyloxyalkyl group can be branched or unbranched. Examples of an alkylene group within an acyloxyalkyl group include, but are not limited to, methylene, ethylene, propylene, butylene, pentylene, hexylene, heptylene, octylene, nonylene, decylene, undecylene, dodecylene, tridecylene, tetradecylene, pentadecylene, hexadecylene, heptadecylene, octadecylene, nonadecylene, icosylene and a stereoisomer thereof. Some non-limiting examples of an acyloxyalkyl group include acyloxymethyl, acyloxyethyl, acyloxypropyl, acyloxy (methyl) propyl and acyloxy (methyl) butyl.

Despite the hydrophobic nature of structural unit (b), it is undesirable for each of R₅, R₆, R₇ and R₈ in formula (3) in the monomeric unit(s) within structural unit (b) to independently comprise a long hydrocarbon chain. Overabundance of long hydrocarbon chains in the monomer unit(s) within structural unit (b) brings about poor interaction of structural unit (b) with the aqueous solvent in the conductive slurry and promotes aggregation of the entire copolymer chain. Winding motion between different copolymer chains might also occur, forming a compact, globular structure. Consequently, the binder material produced therefrom, as well as other materials within the conductive slurry, are unable to be dispersed properly. In some embodiments, no more than three of R₅, R₆, R₇ and R₈ in formula (3) is alkyl, acyloxy or acyloxyalkyl. In certain embodiments, no more than two of R₅, R₆, R₇ and R₈ in formula (3) is alkyl, acyloxy or acyloxyalkyl. In certain embodiments, only one of R₅, R₆, R₇ and R₈ in formula (3) is acyloxy or acyloxyalkyl. In other embodiments, only one of R₅, R₆, R₇ and R₈ in formula (3) is acyloxy. In certain embodiments, only one of R₅, R₆, R₇ and R₈ in formula (3) is acetoxy and the remaining three of each of R₅, R₆, R₇ and R₈ in formula (3) is independently alkyl or H. In further embodiments, only one of R₅, R₆, R₇ and R₈ in formula (3) is acetoxy and the remaining three of each of R₅, R₆, R₇ and R₈ in formula (3) is independently H.

The respective proportions of structural unit (a) and structural unit (b) (or equivalently, the relative proportion of structural unit (a) to structural unit (b)) in the copolymer of the binder material are also critical. If the proportion of structural unit (a) in the copolymer of the binder material were too low, the resulting coating would become brittle upon drying and lead to cracks. Conversely, if the proportion of structural unit (b) in the copolymer of the binder material were too high, the copolymer would be too hydrophobic. This would make the copolymer difficult to disperse homogeneously in an aqueous solvent, which in turn decreases the ease of processing and coating the conductive slurry. A conductive layer obtained from such a conductive slurry would lack the uniformity and evenness that is needed for good electrode and battery performance. When within the desirable ranges, the proportions of the two structural units (a) and (b) in the copolymer of the binder material render the conductive layer effective as a physical barrier for preventing corrosion of the substrate.

When the respective proportions of structural unit (a) and structural unit (b) (the relative proportion of structural unit (a) to structural unit (b)) in the copolymer of the binder material is within the ranges as disclosed below, the copolymer has the optimal balance of hydrophobic and hydrophilic properties. The copolymer would then exhibit exceptional adhesive performance and be easy to disperse homogeneously in an aqueous solvent, while also demonstrating a high level of resistance against re-dissolution in an aqueous solvent. This makes an aqueous conductive slurry comprising the binder material easy to process and allows a conductive layer comprising the binder material to remain adhered to the substrate without reverting to a fluid even when an aqueous cathode slurry is applied on the surface of the conductive layer. This keeps the conductive layer intact on the substrate and forms a physical barrier between the substrate and the electrode layer, reducing the likelihood of corrosion of the substrate. Furthermore, the presence of the conductive layer drives down the interfacial resistance between the electrode layer and the modified current collector, which in turn improves the electrochemical performance of the battery.

In some embodiments, the proportion of structural unit (a) in the copolymer of the binder material is from about 90% to about 99.9%, from about 91% to about 99.9%, from about 92% to about 99.9%, from about 93% to about 99.9%, from about 94% to about 99.9%, from about 95% to about 99.9%, from about 96% to about 99.9%, from about 90% to about 99.5%, from about 91% to about 99.5%, from about 92% to about 99.5%, from about 93% to about 99.5%, from about 94% to about 99.5%, from about 95% to about 99.5%, from about 96% to about 99.5%, from about 90% to about 99%, from about 91% to about 99%, from about 92% to about 99%, from about 93% to about 99%, from about 94% to about 99%, from about 95% to about 99%, from about 90% to about 98.5%, from about 91% to about 98.5%, from about 92% to about 98.5%, from about 93% to about 98.5%, from about 94% to about 98.5%, from about 95% to about 98.5%, from about 90% to about 98%, from about 91% to about 98%, from about 92% to about 98%, from about 93% to about 98%, from about 94% to about 98%, or from about 95% to about 98% by mole, based on the total number of moles of monomeric units in the copolymer.

In some embodiments, the proportion of structural unit (a) in the copolymer of the binder material is less than 100%, less than 99.9%, less than 99.8%, less than 99.7%, less than 99.6%, less than 99.5%, less than 99.4%, less than 99.3%, less than 99.2%, less than 99.1%, less than 99%, less than 98.8%, less than 98.5%, less than 98%, less than 97%, less than 96%, less than 95%, less than 94%, less than 93% or less than 92% by mole, based on the total number of moles of monomeric units in the copolymer. In some embodiments, the proportion of structural unit (a) in the copolymer of the binder material is at least 90%, at least 91%, at least 92%, at least 93%, at least 93.5%, at least 94%, at least 94.5%, at least 95%, at least 95.5%, at least 96%, at least 96.5%, at least 97%, at least 97.5%, or at least 98% by mole, based on the total number of moles of monomeric units in the copolymer.

In some embodiments, the proportion of structural unit (b) in the copolymer of the binder material is from about 0.1% to about 10%, from about 0.1% to about 9%, from about 0.1% to about 8%, from about 0.1% to about 7%, from about 0.1% to about 6%, from about 0.1% to about 5%, from about 0.1% to about 4%, from about 0.5% to about 10%, from about 0.5% to about 9%, from about 0.5% to about 8%, from about 0.5% to about 7%, from about 0.5% to about 6%, from about 0.5% to about 5%, from about 0.5% to about 4%, from about 1% to about 10%, from about 1% to about 9%, from about 1% to about 8%, from about 1% to about 7%, from about 1% to about 6%, from about 1% to about 5%, from about 1% to about 4%, from about 1.5% to about 10%, from about 1.5% to about 9%, from about 1.5% to about 8%, from about 1.5% to about 7%, from about 1.5% to about 6%, from about 1.5% to about 5%, from about 2% to about 10%, from about 2% to about 9%, from about 2% to about 8%, from about 2% to about 7%, from about 2% to about 6%, or from about 2% to about 5% by mole, based on the total number of moles of monomeric units in the copolymer.

In some embodiments, the proportion of structural unit (b) in the copolymer of the binder material is less than 10%, less than 9%, less than 8%, less than 7%, less than 6%, less than 5%, less than 4.5%, less than 4%, less than 3.5%, less than 3%, less than 2.5%, or less than 2% by mole, based on the total number of moles of monomeric units in the copolymer. In some embodiments, the proportion of structural unit (b) in the copolymer of the binder material is at least 0.1%, at least 0.2%, at least 0.4%, at least 0.6%, at least 0.8%, at least 1%, at least 1.2%, at least 1.4%, at least 1.6%, at least 1.8%, at least 2%, at least 3%, at least 4%, at least 5%, at least 6%, at least 7%, or at least 8% by mole, based on the total number of moles of monomeric units in the copolymer.

In some embodiments, the molar ratio of structural unit (a) to structural unit (b) in the copolymer of the binder material is from about 9 to about 1000, from about 9 to about 900, from about 9 to about 800, from about 9 to about 700, from about 9 to about 600, from about 9 to about 500, from about 9 to about 400, from about 9 to about 300, from about 9 to about 200, from about 9 to about 150, from about 9 to about 100, from about 10 to about 1000, from about 10 to about 900, from about 10 to about 800, from about 10 to about 700, from about 10 to about 600, from about 10 to about 500, from about 10 to about 400, from about 10 to about 300, from about 10 to about 200, from about 10 to about 150, from about 10 to about 100, from about 12 to about 500, from about 12 to about 300, from about 12 to about 100, from about 14 to about 500, from about 14 to about 300, from about 14 to about 100, from about 16 to about 500, from about 16 to about 300, from about 16 to about 100, from about 18 to about 500, from about 18 to about 300, or from about 18 to about 100.

In some embodiments, the molar ratio of structural unit (a) to structural unit (b) in the copolymer of the binder material is less than 1000, less than 800, less than 600, less than 400, less than 200, less than 100, less than 80, less than 60, less than 40, less than 30, less than 20, or less than 15. In some embodiments, the molar ratio of structural unit (a) to structural unit (b) in the copolymer of the binder material is more than 9, more than 10, more than 12, more than 14, more than 16, more than 18, more than 20, more than 30, more than 40, more than 50, more than 100, more than 250, more than 500, or more than 700.

The weight-average molecular weight (M_{w}) of the copolymer in the binder material governs the adhesive performance of said copolymer, which affects the ability of the conductive layer to remain adhered to the substrate. The M_{w} of the copolymer is therefore a critical parameter for the mechanical strength of the modified current collector as well as the ability of the conductive layer in preventing corrosion of the substrate. When the weight-average molecular weight of the copolymer in the binder material is within the ranges set forth below, the adhesive performance of said copolymer is improved.

In some embodiments, the weight-average molecular weight (M_{w}) of the copolymer in the binder material is from about 10,000 g/mol to about 300,000 g/mol, from about 15,000 g/mol to about 300,000 g/mol, from about 20,000 g/mol to about 300,000 g/mol, from about 30,000 g/mol to about 300,000 g/mol, from about 40,000 g/mol to about 300,000 g/mol, from about 50,000 g/mol to about 300,000 g/mol, from about 75,000 g/mol to about 300,000 g/mol, from about 100,000 g/mol to about 300,000 g/mol, from about 125,000 g/mol to about 300,000 g/mol, from about 150,000 g/mol to about 300,000 g/mol, from about 200,000 g/mol to about 300,000 g/mol, from about 10,000 g/mol to about 200,000 g/mol, from about 15,000 g/mol to about 200,000 g/mol, from about 20,000 g/mol to about 200,000 g/mol, from about 30,000 g/mol to about 200,000 g/mol, from about 40,000 g/mol to about 200,000 g/mol, from about 50,000 g/mol to about 200,000 g/mol, from about 75,000 g/mol to about 200,000 g/mol, from about 100,000 g/mol to about 200,000 g/mol, from about 10,000 g/mol to about 150,000 g/mol, from about 15,000 g/mol to about 150,000 g/mol, from about 20,000 g/mol to about 150,000 g/mol, from about 30,000 g/mol to about 150,000 g/mol, from about 40,000 g/mol to about 150,000 g/mol, from about 50,000 g/mol to about 150,000 g/mol, or from about 75,000 g/mol to about 150,000 g/mol.

In some embodiments, the weight-average molecular weight of the copolymer in the binder material is less than 300,000 g/mol, less than 250,000 g/mol, less than 200,000 g/mol, less than 175,000 g/mol, less than 150,000 g/mol, less than 125,000 g/mol, less than 100,000 g/mol, less than 90,000 g/mol, less than 80,000 g/mol, less than 70,000 g/mol, less than 60,000 g/mol, or less than 50,000 g/mol. In some embodiments, the weight-average molecular weight of the copolymer in the binder material is more than 10,000 g/mol, more than 15,000 g/mol, more than 20,000 g/mol, more than 25,000 g/mol, more than 30,000 g/mol, more than 35,000 g/mol, more than 40,000 g/mol, more than 50,000 g/mol, more than 60,000 g/mol, more than 70,000 g/mol, more than 80,000 g/mol, more than 100,000 g/mol, or more than 150,000 g/mol.

The viscosity of the binder material relates to the viscosity of a conductive slurry comprising said binder material, and the viscosity of said conductive slurry in turn is an important indicator of the processability of the slurry, and thus the ease of manufacture of a modified current collector using said slurry. When the viscosity of the binder material is within the ranges set forth below, the processability of a conductive slurry comprising said binder material would be optimal. In some embodiments, the viscosity of the binder material at 4% concentration in deionized (DI) water at 20° C. is from about 5 mPa·s to about 80 mPa·s, from about 8 mPa·s to about 80 mPa·s, from about 10 mPa·s to about 80 mPa·s, from about 15 mPa·s to about 80 mPa·s, from about 20 mPa·s to about 80 mPa·s, from about 25 mPa·s to about 80 mPa·s, from about 30 mPa·s to about 80 mPa·s, from about 35 mPa·s to about 80 mPa·s, from about 40 mPa·s to about 80 mPa·s, from about 5 mPa·s to about 50 mPa·s, from about 8 mPa·s to about 50 mPa·s, from about 10 mPa·s to about 50 mPa·s, from about 15 mPa·s to about 50 mPa·s, from about 20 mPa·s to about 50 mPa·s, from about 25 mPa·s to about 50 mPa·s, from about 30 mPa·s to about 50 mPa·s, from about 5 mPa·s to about 30 mPa·s, from about 10 mPa·s to about 30 mPa·s, from about 15 mPa·s to about 30 mPa·s, or from about 5 mPa·s to about 25 mPa·s.

In some embodiments, the viscosity of the binder material at 4% concentration in DI water at 20° C. is less than 80 mPa·s, less than 70 mPa·s, less than 60 mPa·s, less than 50 mPa·s, less than 45 mPa·s, less than 40 mPa·s, less than 35 mPa·s, less than 30 mPa·s, less than 25 mPa·s, less than 20 mPa·s, less than 15 mPa·s, less than 10 mPa·s, or less than 8 mPa·s. In some embodiments, the viscosity of the binder material at 4% concentration in DI water at 20° C. is greater than 5 mPa·s, greater than 7 mPa·s, greater than 10 mPa·s, greater than 15 mPa·s, greater than 20 mPa·s, greater than 25 mPa·s, greater than 30 mPa·s, greater than 35 mPa·s, greater than 40 mPa·s, greater than 45 mPa·s, greater than 50 mPa·s, greater than 60 mPa·s, or greater than 70 mPa·s.

The binder material used in the present invention exhibits great adhesive strength, ensuring that the conductive layer can adhere strongly to the substrate and that the modified current collector of the present invention and cathodes comprising it have excellent mechanical strength. In some embodiments, the adhesive strength between the binder material and the substrate is from about 2 N/cm to about 8 N/cm, from about 2 N/cm to about 7.5 N/cm, from about 2 N/cm to about 7 N/cm, from about 2 N/cm to about 6.5 N/cm, from about 2 N/cm to about 6 N/cm, from about 2 N/cm to about 5.5 N/cm, from about 2 N/cm to about 5 N/cm, from about 2 N/cm to about 4.5 N/cm, from about 2 N/cm to about 4 N/cm, from about 2 N/cm to about 3.8 N/cm, from about 2 N/cm to about 3.6 N/cm, from about 2 N/cm to about 3.4 N/cm, from about 2 N/cm to about 3.2 N/cm, from about 2 N/cm to about 3 N/cm, from about 2.5 N/cm to about 8 N/cm, from about 3 N/cm to about 8 N/cm, from about 3.5 N/cm to about 8 N/cm, from about 4 N/cm to about 8 N/cm, from about 4.5 N/cm to about 8 N/cm, from about 5 N/cm to about 8 N/cm, from about 5.5 N/cm to about 8 N/cm, from about 6 N/cm to about 8 N/cm, from about 3 N/cm to about 7 N/cm, from about 3 N/cm to about 6 N/cm, from about 3 N/cm to about 5.5 N/cm, or from about 4 N/cm to about 6 N/cm.

In some embodiments, the adhesive strength between the binder material and the substrate is less than 8 N/cm, less than 7.5 N/cm, less than 7 N/cm, less than 6.5 N/cm, less than 6 N/cm, less than 5.5 N/cm, less than 5 N/cm, less than 4.5 N/cm, less than 4 N/cm, less than 3.8 N/cm, less than 3.6 N/cm, less than 3.4 N/cm, less than 3.2 N/cm, less than 3 N/cm, less than 2.8 N/cm, or less than 2.6 N/cm. In some embodiments, the adhesive strength between the binder material and the substrate is more than 2 N/cm, more than 2.2 N/cm, more than 2.4 N/cm, more than 2.6 N/cm, more than 2.8 N/cm, more than 3 N/cm, more than 3.2 N/cm, more than 3.4 N/cm, more than 3.6 N/cm, more than 3.8 N/cm, more than 4 N/cm, more than 4.5 N/cm, more than 5 N/cm, more than 5.5 N/cm, more than 6 N/cm, more than 6.5 N/cm, more than 7 N/cm, or more than 7.5 N/cm.

In some embodiments, the conductive layer of the modified current collector comprises a particulate material. The particulate material can be designed to interact with the copolymer of the binder material and provide a framework for the copolymer to build a structure within the conductive layer. As multiple copolymer strands bond with the same particle of the particulate material, the strands intertwine and form a three-dimensional meshed network after the aqueous solvent is removed. The presence of such a meshed network improves the mechanical strength of the conductive layer and any electrode produced therefrom. In addition, the meshed network formed is resistant to dissolution in aqueous solvents, so it can prevent the conductive layer from delaminating when a water-based cathode slurry is applied on top of it to form an electrode layer.

Therefore, it is preferable for a particulate material to be present in the conductive layer, since the particulate material enhances the binding properties of the binder material in the layer.

There are no particular limitations to the type of particulate material used. However, it is preferable that the particles of particulate material to have chemical groups that can easily form chemical interactions with the copolymer of the binder material. Particles with hydroxyl groups or can form hydroxyl groups on their surfaces in an aqueous solvent are particularly suitable as they can interact strongly with the hydrophilic structural unit (a) of the copolymer via hydrogen bonding. In some embodiments, the particulate material is selected from the group consisting of Fe₂O₃, Fe₃O₄, FeO(OH), MnO₂, Al₂O₃, AlO(OH), ZnO, La₂O₃, CeO₂, RuO₂, SiO₂, TiO₂, ZrO₂, Mg(OH)₂, MgO, SnO₂, CaCO₃, BaSO₄, TiN, AlN, Na₂O·mTiO₂, K₂O·nTiO₂, BaOₓ, MTiO₃, and combinations thereof, wherein m is 3 or 6; n is 1, 2, 4, 6, or 8; x is 1 or 2; and M is Ba, Sr, or Ca.

There is no particular limitation to the shape of the particulate material. The shape of the particulate material can be spherical, platelet-shaped, disc-shaped, needle-shaped, cylindrical, irregular, or any other known particle shapes.

The specific surface area of the particulate material particles is a critical parameter. Such a surface area should be large enough for copolymer strands to adhere onto. When the specific surface area of the particulate material particles is within the ranges set forth below, the particulate material is particularly effective at enhancing the binding ability of the copolymer in the conductive layer. In some embodiments, the specific surface area of the particulate material particles is from about 50 m²/g to about 500 m²/g, from about 75 m²/g to about 500 m²/g, from about 100 m²/g to about 500 m²/g, from about 125 m²/g to about 500 m²/g, from about 150 m²/g to about 500 m²/g, from about 175 m²/g to about 500 m²/g, from about 200 m²/g to about 500 m²/g, from about 225 m²/g to about 500 m²/g, from about 250 m²/g to about 500 m²/g, from about 275 m²/g to about 500 m²/g, from about 300 m²/g to about 500 m²/g, from about 325 m²/g to about 500 m²/g, from about 350 m²/g to about 500 m²/g, from about 375 m²/g to about 500 m²/g, from about 400 m²/g to about 500 m²/g, from about 100 m²/g to about 400 m²/g, from about 125 m²/g to about 400 m²/g, from about 150 m²/g to about 400 m²/g, from about 175 m²/g to about 400 m²/g, from about 200 m²/g to about 400 m²/g, from about 225 m²/g to about 400 m²/g, from about 250 m²/g to about 400 m²/g, from about 275 m²/g to about 400 m²/g, from about 300 m²/g to about 400 m²/g, from about 100 m²/g to about 300 m²/g, from about 125 m²/g to about 300 m²/g, from about 150 m²/g to about 300 m²/g, from about 175 m²/g to about 300 m²/g, from about 200 m²/g to about 300 m²/g, from about 225 m²/g to about 300 m²/g, from about 250 m²/g to about 300 m²/g, from about 100 m²/g to about 250 m²/g, from about 125 m²/g to about 250 m²/g, from about 150 m²/g to about 250 m²/g, from about 175 m²/g to about 250 m²/g, or from about 200 m²/g to about 250 m²/g.

In some embodiments, the specific surface area of the particulate material particles is less than 500 m²/g, less than 475 m²/g, less than 450 m²/g, less than 425 m²/g, less than 400 m²/g, less than 375 m²/g, less than 350 m²/g, less than 325 m²/g, less than 300 m²/g, less than 275 m²/g, less than 250 m²/g, less than 225 m²/g, less than 200 m²/g, less than 175 m²/g, less than 150 m²/g, less than 125 m²/g, less than 100 m²/g, or less than 75 m²/g. In some embodiments, the specific surface area of the particulate material particles is more than 50 m²/g, more than 75 m²/g, more than 100 m²/g, more than 125 m²/g, more than 150 m²/g, more than 175 m²/g, more than 200 m²/g, more than 225 m²/g, more than 250 m²/g, more than 275 m²/g, more than 300 m²/g, more than 325 m²/g, more than 350 m²/g, more than 375 m²/g, more than 400 m²/g, more than 425 m²/g, more than 450 m²/g, or more than 475 m²/g.

The proportions of each of the binder material and the conductive material (and the particulate material if present) within the conductive layer of the modified current collector are of paramount importance with respect to the effectiveness of the conductive layer in forming an unyielding conductive layer structure, reducing corrosion tendency of the substrate, and minimizing the interfacial resistance between the electrode layer and the modified current collector. For example, an insufficient amount of conductive material within the conductive layer would not form a conductive network that can facilitate efficient and effective transfer of electrons between the electrode layer and the substrate. Similarly, a conductive layer deficient in binder material might have difficulty holding the entire conductive layer in place, leading to delamination of the conductive layer. A deficiency in particulate material in the conductive layer would render the particulate material ineffective in improving the mechanical strength of the conductive layer and the layer's ability to perform as an anti-corrosion barrier. When the proportions of each of the binder material, the particulate material, and the conductive material within the conductive layer of the modified current collector are within the ranges set forth below, electrodes produced therefrom have improved mechanical strength and decreased interfacial resistance between electrode layer and substrate, and corrosion of the substrate can be prevented. Batteries comprising such an electrode therefore have excellent electrochemical performance.

In some embodiments, the proportion of each of the binder material and the conductive material within the conductive layer of the modified current collector is independently from about 20% to about 75%, from about 25% to about 75%, from about 30% to about 75%, from about 35% to about 75%, from about 40% to about 75%, from about 45% to about 75%, from about 50% to about 75%, from about 55% to about 75%, from about 60% to about 75%, from about 20% to about 70%, from about 25% to about 70%, from about 30% to about 70%, from about 35% to about 70%, from about 40% to about 70%, from about 45% to about 70%, from about 50% to about 70%, from about 55% to about 70%, from about 20% to about 65%, from about 25% to about 65%, from about 30% to about 65%, from about 35% to about 65%, from about 40% to about 65%, from about 45% to about 65%, from about 50% to about 65%, from about 20% to about 60%, from about 25% to about 60%, from about 30% to about 60%, from about 35% to about 60%, from about 40% to about 60%, from about 45% to about 60%, from about 20% to about 55%, from about 25% to about 55%, from about 30% to about 55%, from about 35% to about 55%, from about 40% to about 55%, from about 20% to about 50%, from about 25% to about 50%, from about 30% to about 50%, or from about 35% to about 50% by weight, based on the total weight of the conductive layer.

In some embodiments, the proportion of each of the binder material and the conductive material within the conductive layer of the modified current collector is independently less than 75%, less than 70%, less than 65%, less than 60%, less than 55%, less than 50%, less than 45%, less than 40%, less than 35%, less than 30%, or less than 25% by weight, based on the total weight of the conductive layer. In some embodiments, the proportion of each of the binder material and the conductive material within the conductive layer of the modified current collector is independently more than 20%, more than 25%, more than 30%, more than 35%, more than 40%, more than 45%, more than 50%, more than 55%, more than 60%, more than 65%, or more than 70% by weight, based on the total weight of the conductive layer.

In some embodiments, the proportion of particulate material in the conductive layer is from about 0.1% to about 5%, from about 0.5% to about 5%, from about 1% to about 5%, from about 1.5% to about 5%, from about 2% to about 5%, from about 2.5% to about 5%, from about 3% to about 5%, from about 3.5% to about 5%, from about 4% to about 5%, from about 0.1% to about 4%, from about 0.5% to about 4%, from about 1% to about 4%, from about 1.5% to about 4%, from about 2% to about 4%, from about 2.5% to about 4%, from about 3% to about 4%, from about 0.1% to about 3%, from about 0.5% to about 3%, from about 1% to about 3%, from about 1.5% to about 3%, from about 2% to about 3%, or from about 2.5% to about 3% by weight, based on the total weight of the conductive layer. In certain embodiments, the conductive layer does not comprise a particulate material.

In some embodiments, the proportion of particulate material in the conductive layer is less than 5%, less than 4.5%, less than 4%, less than 3.5%, less than 3%, less than 2.5%, less than 2%, less than 1.5%, less than 1%, or less than 0.5% by weight, based on the total weight of the conductive layer. In some embodiments, the proportion of particulate material in the conductive layer is more than 0.1%, more than 0.5%, more than 1%, more than 1.5%, more than 2%, more than 2.5%, more than 3%, more than 3.5%, more than 4%, or more than 4.5% by weight, based on the total weight of the conductive layer.

The proportion of the metal compound present in the conductive layer is critical in ensuring that the metal ions irreversibly lost in SEI formation during initial charging are sufficiently compensated by the metal ions present in the metal compound. The amount of metal ions present in the metal compound should be sufficient and approximately equivalent to the amount of metal ions irreversibly lost by the cathode active material in the electrode layer for SEI formation during initial charging. The amount of metal ions present in the metal compound depends at least on the composition of the metal compound and the amount of metal compound added to the conductive layer, so it can be controlled by varying these two parameters.

In some embodiments, the proportion of the metal compound present in the conductive layer is from about 5% to about 30%, from about 7.5% to about 30%, from about 10% to about 30%, from about 12.5% to about 30%, from about 15% to about 30%, from about 17.5% to about 30%, from about 20% to about 30%, from about 22.5% to about 30%, from about 25% to about 30%, from about 27.5% to about 30%, from about 5% to about 25%, from about 7.5% to about 25%, from about 10% to about 25%, from about 12.5% to about 25%, from about 15% to about 25%, from about 17.5% to about 25%, from about 20% to about 25%, from about 22.5% to about 25%, from about 5% to about 20%, from about 7.5% to about 20%, from about 10% to about 20%, from about 12.5% to about 20%, from about 15% to about 20%, from about 17.5% to about 20%, from about 5% to about 15%, from about 7.5% to about 15%, from about 10% to about 15%, from about 12.5% to about 15%, from about 5% to about 10%, or from about 7.5% to about 10% by weight, based on the total weight of the conductive layer.

In some embodiments, the proportion of the metal compound present in the conductive layer is less than 30%, less than 27.5%, less than 25%, less than 22.5%, less than 20%, less than 17.5%, less than 15%, less than 12.5%, less than 10%, or less than 7.5% by weight, based on the total weight of the conductive layer. In some embodiments, the proportion of the metal compound present in the conductive layer is more than 5%, more than 7.5%, more than 10%, more than 12.5%, more than 15%, more than 17.5%, more than 20%, more than 22.5%, more than 25%, or more than 27.5% by weight, based on the total weight of the conductive layer.

In certain embodiments, the conductive layer additionally comprises a surfactant or a dispersing agent. These surface-active agents might be added during the production of the conductive slurry to enhance the dispersibility of the conductive material in the slurry. There is no particular limitation with respect to the type of surfactant or dispersing agent used, except that it should be capable of dispersing the conductive material within the conductive slurry without affecting the overall performance of the resultant conductive layer. In other embodiments, the conductive layer does not comprise a surfactant or a dispersing agent.

In some embodiments, the proportion of surfactant or dispersing agent in the conductive layer is from about 0.1% to about 5%, from about 0.5% to about 5%, from about 1% to about 5%, from about 1.5% to about 5%, from about 2% to about 5%, from about 2.5% to about 5%, from about 3% to about 5%, from about 0.1% to about 4%, from about 0.5% to about 4%, from about 1% to about 4%, from about 1.5% to about 4%, from about 2% to about 4%, from about 0.1% to about 3%, from about 0.5% to about 3%, from about 1% to about 3%, from about 0.1% to about 2.5%, from about 0.5% to about 2.5%, from about 1% to about 2.5%, from about 1.5% to about 2.5%, or from about 2% to about 2.5% by weight, based on the total weight of the conductive layer.

In some embodiments, the proportion of surfactant or dispersing agent in the conductive layer is less than 5%, less than 4.5%, less than 4%, less than 3.5%, less than 3%, less than 2.5%, less than 2%, less than 1.5%, less than 1%, or less than 0.5% by weight, based on the total weight of the conductive layer. In some embodiments, the proportion of surfactant or dispersing agent in the conductive layer is more than 0.1%, more than 0.5%, more than 1%, more than 1.5%, more than 2%, more than 2.5%, more than 3%, more than 3.5%, more than 4%, or more than 4.5% by weight, based on the total weight of the conductive layer.

The thickness of the modified current collector in a cathode may affect the volume it occupies within the battery, the room available for the cathode active material in the electrode layer, and hence the capacity of the battery. In certain embodiments, the modified current collector has a thickness of from about 5 μm to about 70 μm, from about 5 μm to about 60 μm, from about 5 μm to about 50 μm, from about 5 μm to about 40 μm, from about 5 μm to about 30 μm, from about 5 μm to about 20 μm, from about 10 μm to about 70 μm, from about 10 μm to about 60 μm, from about 10 μm to about 50 μm, from about 10 μm to about 40 μm, from about 10 μm to about 30 μm, from about 15 μm to about 70 μm, from about 15 μm to about 60 μm, from about 15 μm to about 50 μm, from about 15 μm to about 40 μm, from about 15 μm to about 30 μm, from about 20 μm to about 70 μm, from about 20 μm to about 60 μm, from about μm to about 50 μm, from about 20 μm to about 40 μm, from about 25 μm to about 70 μm, from about 25 μm to about 60 μm, from about 25 μm to about 50 μm, or from about 25 μm to about 40 μm.

In some embodiments, the modified current collector has a thickness of less than 70 μm, less than 60 μm, less than 50 μm, less than 40 μm, less than 30 μm, less than 25 μm, less than 20 μm, less than 15 μm, or less than 10 μm. In some embodiments, the modified current collector has a thickness of more than 5 μm, more than 10 μm, more than 15 μm, more than 20 μm, more than 25 μm, more than 30 μm, more than 40 μm, more than 50 μm, or more than 60 μm.

The thickness of the substrate of a modified current collector may affect the volume it occupies within the modified current collector and/or the cathode. This might influence the available space for conductive material and binder material in the conductive layer and/or cathode active material in the electrode layer. Thus, it is possible for the thickness of the substrate to affect the electrical conductivity and capacity of the battery system and the adhesive performance of the conductive layer to the substrate. In some embodiments, the substrate of the modified current collector has a thickness of from about 5 μm to about 50 μm, from about 5 μm to about 45 μm, from about 5 μm to about 40 μm, from about 5 μm to about 35 μm, from about 5 μm to about 30 μm, from about 5 μm to about 25 μm, from about 10 μm to about 50 μm, from about 10 μm to about 45 μm, from about 10 μm to about 40 μm, from about 10 μm to about 35 μm, from about 10 μm to about 30 μm, from about 15 μm to about 50 μm, from about 15 μm to about 45 μm, from about 15 μm to about 40 μm, from about 15 μm to about 35 μm, from about μm to about 50 μm, from about 20 μm to about 45 μm, or from about 20 μm to about 40 μm.

In some embodiments, the substrate of the modified current collector has a thickness of less than 50 μm, less than 45 μm, less than 40 μm, less than 35 μm, less than 30 μm, less than 25 μm, less than 20 μm, less than 15 μm, or less than 10 μm. In some embodiments, the substrate of the modified current collector has a thickness of more than 5 μm, more than 10 μm, more than 15 μm, more than 20 μm, more than 25 μm, more than 30 μm, more than 35 μm, more than 40 μm, or more than 45 μm.

Similarly, the thickness of the conductive layer affects the total volume of the modified current collector, which in turn affects the total volume occupied by a cathode comprising the modified current collector and the corresponding amount of cathode active material needed in the electrode layer of the cathode. Thus, the thickness of the conductive layer affects the capacity of the battery. In some embodiments, the conductive layer in the modified current collector has a thickness of from about 0.1 μm to about 20 μm, from about 0.1 μm to about 16 μm, from about 0.1 μm to about 12 μm, from about 0.1 μm to about 10 μm, from about 0.1 μm to about 5 μm, from about 1 μm to about 20 μm, from about 1 μm to about 16 μm, from about 1 μm to about 12 μm, from about 1 μm to about 10 μm, from about 1 μm to about 5 μm, from about 2 μm to about 20 μm, from about 2 μm to about 16 μm, from about 2 μm to about 12 μm, from about 2 μm to about 10 μm, from about 2 μm to about 5 μm, from about 3 μm to about μm, from about 3 μm to about 16 μm, from about 3 μm to about 12 μm, from about 3 μm to about 10 μm, from about 3 μm to about 5 μm, from about 4 μm to about 20 μm, from about 4 μm to about 16 μm, from about 4 μm to about 12 μm, or from about 4 μm to about 10 μm.

In some embodiments, the conductive layer in the modified current collector has a thickness of less than 20 μm, less than 18 μm, less than 16 μm, less than 14 μm, less than 12 μm, less than 10 μm, less than 8 μm, less than 6 μm, less than 4 μm, less than 2 μm, or less than 1 μm. In some embodiments, the conductive layer in the modified current collector has a thickness of more than 0.1 μm, more than 0.5 μm, more than 1 μm, more than 2 μm, more than 4 μm, more than 6 μm, more than 8 μm, more than 10 μm, more than 12 μm, more than 14 μm, more than 16 μm, or more than 18 μm.

As mentioned above, in some embodiments, the conductive layer in a modified current collector of the present invention is produced via a conductive slurry. In some embodiments, the conductive slurry comprises a conductive material, a metal compound, a binder material, and a solvent. In certain embodiments, the conductive layer additionally comprises a particulate material, so the conductive slurry also comprises a particulate material. In some embodiments, the binder material comprises a copolymer as discussed above. In some embodiments, the solvent in a conductive slurry is an aqueous solvent.

In certain embodiments, the aqueous solvent is water. In some embodiments, the aqueous solvent is selected from the group consisting of tap water, bottled water, purified water, pure water, distilled water, deionized water (DI water), D₂O, and combinations thereof.

In some embodiments, the aqueous solvent in the conductive slurry further comprises a minor component in addition to water. In some embodiments, the volume ratio of water to the minor component is from about 51:49 to about 99:1. Any water-miscible or volatile solvents can be used as the minor component of the aqueous solvent. Some non-limiting examples of the minor component include alcohols, lower aliphatic ketones, lower alkyl acetates, and combinations thereof. The addition of a minor component can improve the processability of the conductive slurry.

Some non-limiting examples of the alcohol include C₁-C₄ alcohols, such as methanol, ethanol, isopropanol, n-propanol, tert-butanol, n-butanol, 1,2-butanediol, 1,3-butanediol, 1,4-butanediol, 2,3-butanediol, ethylene glycol, propylene glycol, glycerol, and combinations thereof. Some non-limiting examples of the lower aliphatic ketones include acetone, dimethyl ketone, methyl ethyl ketone (MEK), and combinations thereof. Some non-limiting examples of the lower alkyl acetates include ethyl acetate (EA), isopropyl acetate, propyl acetate, butyl acetate (BA), and combinations thereof. Some other non-limiting examples of the water-miscible solvents or volatile solvents include 1,4-dioxane, diethyl ether, methyl tert-butyl ether, cyclopentyl methyl ether, tetrahydrofuran (THF), 2-methyl tetrahydrofuran, acetonitrile, dimethyl sulfoxide (DMSO), sulfolane, nitromethane, propylene carbonate, ethylene carbonate, dimethyl carbonate, pyridine, acetaldehyde, formic acid, acetic acid, propanoic acid, butyric acid, γ-valerolactone (GVL), furfuryl alcohol, methyl lactate, ethyl lactate, diethanolamine, dimethylacetamide (DMAc), dimethylformamide (DMF), N-methylpyrrolidone (NMP), dihydrolevoglucosenone (Cyrene™), N,N′-dimethylpropyleneurea (DMPU), and dimethyl isosorbide (DMI). In some embodiments, no minor component is present in the aqueous solvent of the conductive slurry.

In some embodiments, the solid content of the conductive slurry is from about 5% to about 25%, from about 6% to about 25%, from about 7% to about 25%, from about 8% to about 25%, from about 9% to about 25%, from about 10% to about 25%, from about 11% to about 25%, from about 12% to about 25%, from about 13% to about 25%, from about 14% to about 25%, from about 15% to about 25%, from about 5% to about 20%, from about 6% to about 20%, from about 7% to about 20%, from about 8% to about 20%, from about 9% to about 20%, from about 10% to about 20%, from about 5% to about 17%, from about 6% to about 17%, from about 7% to about 17%, from about 8% to about 17%, from about 9% to about 17%, from about 10% to about 17%, from about 5% to about 15%, from about 6% to about 15%, from about 7% to about 15%, from about 8% to about 15%, from about 9% to about 15%, or from about 10% to about 15% by weight, based on the total weight of the conductive slurry.

In some embodiments, the solid content of the conductive slurry is less than 25%, less than 23%, less than 20%, less than 19%, less than 18%, less than 17%, less than 16%, less than 15%, less than 14%, less than 13%, less than 10%, less than 8%, or less than 6% by weight, based on the total weight of the conductive slurry. In some embodiments, the solid content of the conductive slurry is more than 5%, more than 6%, more than 7%, more than 8%, more than 9%, more than 10%, more than 11%, more than 12%, more than 13%, more than 14%, more than 15%, more than 16%, more than 17%, more than 18%, more than 19%, more than 20%, or more than 22% by weight, based on the total weight of the conductive slurry.

To improve the dispersion of the metal compound in the conductive slurry, it is preferable that the metal compound should dissolve well in the aqueous solvent of the conductive slurry. Homogeneous dispersion of the metal compound in the conductive slurry ensures even distribution of the metal compound within the resultant conductive layer, which in turn ensures the metal compound can replace the metal ions lost during initial charging in a consistent manner throughout the modified current collector. In some embodiments, the solubility of the metal compound in the aqueous solvent of the conductive slurry is greater than 8 g/L, greater than 10 g/L, greater than 15 g/L, greater than 20 g/L, greater than 25 g/L, greater than 30 g/L, greater than 40 g/L, greater than 50 g/L, greater than 75 g/L, greater than 100 g/L, greater than 150 g/L, greater than 200 g/L, greater than 250 g/L, greater than 300 g/L, greater than 400 g/L, greater than 500 g/L, greater than 600 g/L, greater than 800 g/L, or greater than 1,000 g/L.

The amount of metal compound present in the conductive slurry can be expressed in terms of the concentration of the metal compound in the conductive slurry. In some embodiments, the concentration of the metal compound in the conductive slurry is from about 0.01 M to about 3 M, from about 0.05 M to about 3 M, from about 0.1 M to about 3 M, from about 0.15 M to about 3 M, from about 0.2 M to about 3 M, from about 0.25 M to about 3 M, from about 0.3 M to about 3 M, from about 0.35 M to about 3 M, from about 0.4 M to about 3 M, from about 0.45 M to about 3 M, from about 0.5 M to about 3 M, from about 0.55 M to about 3 M, from about 0.6 M to about 3 M, from about 0.8 M to about 3 M, from about 1 M to about 3 M, from about 1.5 M to about 3 M, from about 2 M to about 3 M, from about 0.05 M to about 2 M, from about 0.1 M to about 2 M, from about 0.15 M to about 2 M, from about 0.2 M to about 2 M, from about 0.25 M to about 2 M, from about 0.3 M to about 2 M, from about 0.4 M to about 2 M, from about 0.5 M to about 2 M, from about 0.6 M to about 2 M, from about 0.8 M to about 2 M, from about 1 M to about 2 M, from about 0.01 M to about 1.5 M, from about 0.05 M to about 1.5 M, from about 0.1 M to about 1.5 M, from about 0.15 M to about 1.5 M, from about 0.2 M to about 1.5 M, from about 0.25 M to about 1.5 M, from about 0.3 M to about 1.5 M, from about 0.4 M to about 1.5 M, from about 0.5 M to about 1.5 M, from about 0.01 M to about 1 M, from about 0.05 M to about 1 M, from about 0.1 M to about 1 M, from about 0.15 M to about 1 M, from about 0.2 M to about 1 M, from about 0.25 M to about 1 M, from about 0.3 M to about 1 M, from about 0.4 M to about 1 M, from about 0.5 M to about 1 M, from about 0.01 M to about 0.8 M, from about 0.05 M to about 0.8 M, from about 0.1 M to about 0.8 M, from about 0.15 M to about 0.8 M, from about 0.2 M to about 0.8 M, from about 0.25 M to about 0.8 M, from about 0.3 M to about 0.8 M, from about 0.4 M to about 0.8 M, from about 0.01 M to about 0.6 M, from about 0.05 M to about 0.6 M, from about 0.1 M to about 0.6 M, from about 0.15 M to about 0.6 M, from about 0.2 M to about 0.6 M, from about 0.25 M to about 0.6 M, or from about 0.3 M to about 0.6 M.

In some embodiments, the concentration of the metal compound in the conductive slurry is less than 2 M, less than 1.5 M, less than 1 M, less than 0.9 M, less than 0.8 M, less than 0.7 M, less than 0.6 M, less than 0.55 M, less than 0.5 M, less than 0.45 M, less than 0.4 M, less than 0.35 M, less than 0.3 M, less than 0.25 M, or less than 0.2 M. In some embodiments, the concentration of the metal compound in the conductive slurry is more than 0.01 M, more than 0.05 M, more than 0.1 M, more than 0.15 M, more than 0.2 M, more than 0.25 M, more than 0.3 M, more than 0.35 M, more than 0.4 M, more than 0.5 M, more than 0.6 M, more than 0.8 M, more than 1 M, or more than 1.5 M.

There are no particular limitations on the method used to produce a conductive slurry, except that all components of the slurry (e.g., conductive material, metal compound, binder material, particulate material, aqueous solvent) should be mixed evenly to form a homogeneous slurry, for example, through the use of a homogenizer. In some embodiments, all the components of the conductive slurry are added into the homogenizer in a single batch. In other embodiments, each component of the conductive slurry can be added to the homogenizer in one or more batches, and each batch may comprise one or more components. However, when the conductive slurry comprises surfactant or dispersing agent, it is preferable for the surfactant or dispersing agent to be added into the homogenizer before the addition of the conductive material, in order to ensure that the conductive material can be well dispersed in the slurry via the action of the surfactant or dispersing agent.

Any homogenizer that can reduce or eliminate particle aggregation and/or promote homogeneous distribution of the various components of the conductive slurry can be used herein. In some embodiments, the homogenizer is a planetary stirring mixer, a stirring mixer, a blender, or an ultrasonicator. There are no particular limitations to the stirring speed and time taken, except that they should be sufficient to enable good dispersion of the various slurry components in the aqueous solvent, in order to ensure that when the conductive slurry is coated onto a substrate, the coating can be homogeneous.

In addition, there are no particular limitations to the temperature at which the homogenization of the conductive slurry is performed, except that it should not be so high as to cause boiling of the aqueous solvent, but at the same time be sufficiently high to ensure that the slurry is not so viscous as to be difficult to process and that the binder material can be readily dissolved in the slurry. In some embodiments, homogenization of the conductive slurry is performed at a temperature of from about 20° C. to about 95° C., from about 25° C. to about 95° C., from about 30° C. to about 95° C., from about 20° C. to about 75° C., from about 25° C. to about 75° C., from about 30° C. to about 75° C., from about 35° C. to about 75° C., from about 40° C. to about 75° C., from about 20° C. to about 60° C., from about 25° C. to about 60° C., from about 30° C. to about 60° C., from about 35° C. to about 60° C., from about 40° C. to about 60° C., from about 25° C. to about 50° C., or from about 30° C. to about 50° C.

In some embodiments, homogenization of the conductive slurry is performed at a temperature below 95° C., below 85° C., below 75° C., below 65° C., below 55° C., below 50° C., below 45° C., below 40° C., below 35° C., below 30° C., or below 25° C. In some embodiments, homogenization of the conductive slurry is performed at a temperature above 20° C., above 25° C., above 30° C., above 35° C., above 40° C., above 45° C., above 50° C., above 55° C., above 60° C., above 65° C., above 70° C., or above 75° C.

In some embodiments, after homogenization of the conductive slurry, the slurry can be coated onto one side or both sides of a substrate to form a conductive layer film. There are no particular limitations to the equipment and the conditions used in coating the conductive slurry, except that a homogeneous, flat and smooth coated layer should be formed as a result. In certain embodiments, the coating process is performed using a doctor blade coater, a slot-die coater, a transfer coater, a spray coater, a roll coater, a gravure coater, a dip coater, or a curtain coater.

In some embodiments, following the coating of the conductive slurry onto a substrate, the conductive layer film is dried to form the conductive layer and complete the modified current collector of the present invention. Any equipment that can dry the conductive layer film to affix the resultant conductive layer to the substrate can be used herein, but it is preferable for the drying process to involve heating. Heating causes the formation of the meshed copolymer network, which, as explained above, improve the adhesive properties of the copolymer and prevents the conductive layer from redissolving upon subsequent contact with the solvent of the cathode slurry. Some non-limiting examples of suitable drying equipment include a vacuum drying oven, batch drying oven, a conveyor drying oven, and a microwave drying oven.

There are no particular limitations to the conditions used to dry the conductive layer film, except that the drying conditions should be sufficient to ensure that the conductive layer adheres strongly to the substrate and that heating above room temperature occurs in the drying process. However, drying the conductive layer film at temperatures above 150° C. may result in undesirable deformation of the resultant modified current collector, thus affecting the performance of any cathode prepared therefrom. The drying temperature should be optimized with respect to the other drying conditions, such as drying time, in order to ensure that the aqueous solvent is sufficiently removed from the conductive layer film. In some embodiments, when a vacuum drying oven is used in the drying process, the pressure in the vacuum drying oven is below 10 kPa, below 9 kPa, below 8 kPa, below 7 kPa, below 6 kPa, below 5 kPa, below 4 kPa, below 3 kPa, below 2 kPa, or below 1 kPa.

In some embodiments, the modified current collector is compressed mechanically following drying in order to increase the density of the conductive layer. In other embodiments, the modified current collector is not compressed.

A cathode can subsequently be prepared using a modified current collector of the present invention by forming an electrode layer on the modified current collector. There are no particular limitations on the composition of the electrode layer, and any compositions known in the art are suitable for use in the present invention, as long as any battery comprising such cathodes can achieve good electrochemical performance. The composition of such electrode layers depends on the type of battery that is being produced. In some embodiments, the type of battery may be a primary battery or a secondary battery. Some non-limiting examples of battery types include alkaline batteries, aluminum-air batteries, lithium batteries, lithium air batteries, magnesium batteries, silver-oxide batteries, zinc-air batteries, aluminum-ion batteries, lead-acid batteries, lithium-ion batteries, magnesium-ion batteries, potassium-ion batteries, sodium-ion batteries, sodium-air batteries, silicon-air batteries, zinc-ion batteries, and sodium-sulfur batteries. Furthermore, depending on the state of the electrolyte being used (i.e., liquid or solid state), batteries can be classified as conventional batteries (when liquid electrolyte is used) or solid-state batteries (when solid electrolyte is used).

In some embodiments, the electrode layer comprises a cathode active material and a binding agent. In certain embodiments, the electrode layer additionally comprises a conductive agent.

In some embodiments, the cathode active material is selected from the group consisting of LiCoO₂, LiNiO₂, LiNi₁₋ₓMₓO₂, LiNiₓMn_{y}O₂, LiCoₓNi_{y}O₂, Li_{1+z}NiₓMn_{y}Co_{1-x-y}O₂, LiNiₓCo_{y}Al_{z}O₂, LiV₂O₅, LiTiS₂, LiMoS₂, LiMnO₂, LiCrO₂, LiMn₂O₄, Li₂MnO₃, LiFeO₂, LiFePO₄, and combinations thereof, wherein each x is independently from 0.1 to 0.9; each y is independently from 0 to 0.9; each z is independently from 0 to 0.4; and M is selected from the group consisting of Co, Mn, Al, Fe, Ti, Ga, Mg, and combinations thereof. In certain embodiments, each x in the above general formulae is independently selected from 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875 and 0.9; each y in the above general formulae is independently selected from 0, 0.025, 0.05, 0.075, 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875 and 0.9; each z in the above general formulae is independently selected from 0, 0.025, 0.05, 0.075, 0.1, 0.125, 0.15, 0.175, 0.2, 0.225, 0.25, 0.275, 0.3, 0.325, 0.35, 0.375 and 0.4. In some embodiments, each x, y and z in the above general formulae independently has a 0.01 interval.

In certain embodiments, the cathode active material is selected from the group consisting of LiNiₓMn_{y}O₂, Li_{1+z}NiₓMn_{y}Co_{1-x-y}O₂ (NMC), LiNiₓCo_{y}AlO₂ (NCA), LiCoₓNi_{y}O₂, and combinations thereof, wherein each x is independently from 0.4 to 0.6; each y is independently from 0.2 to 0.4; and each z is independently from 0 to 0.1. In other embodiments, the cathode active material is not LiCoO₂, LiNiO₂, LiV₂O₅, LiTiS₂, LiMoS₂, LiMnO₂, LiCrO₂, LiMn₂O₄, LiFeO₂ or LiFePO₄. In further embodiments, the cathode active material is not LiNiₓMn_{y}O₂, Li_{1+z}NiₓMn_{y}Co_{1-x-y}O₂, LiNiₓCo_{y}Al_{z}O₂ or LiCoₓNi_{y}O₂, wherein each x is independently from 0.1 to 0.9; each y is independently from 0 to 0.45; and each z is independently from 0 to 0.2. In certain embodiments, the cathode active material is Li₁₊ₓNiₐMn_{b}Co_{c}Al_{(1-a-b-c)}O₂; wherein −0.2≤x≤0.2, 0≤a<1, 0≤b<1, 0≤c<1, and a+b+c≤1. In some embodiments, the cathode active material has the general formula Li₁₊ₓNiₐMn_{b}Co_{c}Al_{(1-a-b-c)}O₂, with 0.33≤a≤0.92, 0.33≤a≤0.9, 0.33≤a≤0.8, 0.4≤a≤0.92, 0.4≤a≤0.9, 0.4≤a≤0.8, 0.5≤a≤0.92, 0.5≤a≤0.9, 0.5≤a≤0.8, 0.6≤a≤0.92, or 0.6≤a≤0.9; 0≤b≤0.5, 0≤b≤0.4, 0≤b≤0.3, 0≤b≤0.2, 0.1≤b≤0.5, 0.1≤b≤0.4, 0.1≤b≤0.3, 0.1≤b≤0.2, 0.2≤b≤0.5, 0.2≤b≤0.4, or 0.2≤b≤0.3; 0≤c≤0.5, 0≤c≤0.4, 0≤c≤0.3, 0.1≤c≤0.5, 0.1≤c≤0.4, 0.1≤c≤0.3, 0.1≤c≤0.2, 0.2≤c≤0.5, 0.2≤c≤0.4, or 0.2≤c≤0.3. In some embodiments, the cathode active material has the general formula LiMPO₄, wherein M is selected from the group consisting of Fe, Co, Ni, Mn, Al, Mg, Zn, Ti, La, Ce, Sn, Zr, Ru, Si, Ge, and combinations thereof.

In some embodiments, the cathode active material is selected from the group consisting of LiFePO₄, LiCoPO₄, LiNiPO₄, LiMnPO₄, LiMnFePO₄, LiMnₓFe₍₁₋ₓ₎PO₄, and combinations thereof; wherein 0<x<1. In some embodiments, the cathode active material is LiNiₓMn_{y}O₄; wherein 0.1≤x≤0.9 and 0≤y≤2. In certain embodiments, the cathode active material is xLi₂MnO₃₍₁₋ₓ₎LiMO₂, wherein M is selected from the group consisting of Ni, Co, Mn, and combinations thereof; and wherein 0<x<1. In some embodiments, the cathode active material is Li₃V₂(PO₄)₃, or LiVPO₄F. In certain embodiments, the cathode active material has the general formula Li₂MSiO₄, wherein M is selected from the group consisting of Fe, Co, Mn, Ni, and combinations thereof.

In certain embodiments, the cathode active material is doped with a dopant selected from the group consisting of Co, Cr, V, Mo, Nb, Pd, F, Na, Fe, Ni, Mn, Al, Mg, Zn, Ti, La, Ce, Sn, Zr, Ru, Si, Ge, and combinations thereof. In some embodiments, the cathode active material is not doped with Co, Cr, V, Mo, Nb, Pd, F, Na, Fe, Ni, Mn, Mg, Zn, Ti, La, Ce, Ru, Si, or Ge. In certain embodiments, the cathode active material is not doped with Al, Sn or Zr.

In some embodiments, the cathode active material is LiNi_{0.33}Mn_{0.33}Co_{0.33}O₂ (NMC333), LiNi_{0.4}Mn_{0.4}Co_{0.2}O₂, LiNi_{0.5}Mn_{0.3}Co_{0.2}O₂ (NMC532), LiNi_{0.6}Mn_{0.2}Co_{0.2}O₂ (NMC622), LiNi_{0.7}Mn_{0.15}Co_{0.15}O₂, LiNi_{0.7}Mn_{0.1}Co_{0.2}O₂, LiNi_{0.8}Mn_{0.1}Co_{0.1}O₂ (NMC811), LiNi_{0.92}Mn_{0.04}Co_{0.04}O₂, LiNi_{0.85}Mn_{0.075}Co_{0.075}O₂, LiNi_{0.8}Co_{0.15}Al_{0.05}O₂, LiNi_{0.88}Co_{0.1}Al_{0.02}O₂, LiNiO₂ (LNO), or a combination thereof.

In other embodiments, the cathode active material is not LiCoO₂, LiNiO₂, LiMnO₂, LiMn₂O₄ or Li₂MnO₃. In further embodiments, the cathode active material is not LiNi_{0.33}Mn_{0.33}Co_{0.33}O₂, LiNi_{0.4}Mn_{0.4}Co_{0.2}O₂, LiNi_{0.5}Mn_{0.3}Co_{0.2}O₂, LiNi_{0.6}Mn_{0.2}Co_{0.2}O₂, LiNi_{0.7}Mn_{0.15}Co_{0.15}O₂, LiNi_{0.7}Mn_{0.1}Co_{0.2}O₂, LiNi_{0.8}Mn_{0.1}Co_{0.1}O₂, LiNi_{0.92}Mn_{0.04}Co_{0.04}O₂, LiNi_{0.85}Mn_{0.075}Co_{0.075}O₂, LiNi_{0.8}Co_{0.15}Al_{0.05}O₂, or LiNi_{0.88}Co_{0.1}Al_{0.02}O₂.

In certain embodiments, the cathode active material comprises or is a core-shell composite having a core and shell structure, wherein the core comprises a lithium transition metal oxide selected from the group consisting of Li₁₊ₓNiₐMn_{b}Co_{c}Al_{(1-a-b-c)}O₂, LiCoO₂, LiNiO₂, LiMnO₂, LiMn₂O₄, Li₂MnO₃, LiCrO₂, Li₄Ti₅O₁₂, LiV₂O₅, LiTiS₂, LiMoS₂, LiCoₐNi_{b}O₂, LiMnₐNi_{b}O₂, and combinations thereof; wherein −0.2≤x≤0.2, 0≤a<1, 0≤b<1, 0≤c<1, and a+b+c≤1. In some embodiments, the shell also comprises a lithium transition metal oxide. In certain embodiments, the lithium transition metal oxide of the shell is selected from the above-mentioned group of lithium transitional metal oxides used for the core. In other embodiments, the shell comprises a transition metal oxide. In certain embodiments, the transition metal oxide of the shell is selected from the group consisting of Fe₂O₃, MnO₂, Al₂O₃, MgO, ZnO, TiO₂, La₂O₃, CeO₂, SnO₂, ZrO₂, RuO₂, and combinations thereof. In certain embodiments, the shell comprises a lithium transition metal oxide and a transition metal oxide.

In certain embodiments, the core and the shell each independently comprise two or more lithium transition metal oxides. In some embodiments, one of the core or shell comprises only one lithium transition metal oxide, while the other comprises two or more lithium transition metal oxides. The lithium transition metal oxide or oxides in the core and the shell may be the same, or they may be different or partially different. In some embodiments, the two or more lithium transition metal oxides are uniformly distributed over the core. In certain embodiments, the two or more lithium transition metal oxides are not uniformly distributed over the core.

In some embodiments, each of the metal oxides in the core and the shell is independently doped with a dopant selected from the group consisting of Co, Cr, V, Mo, Nb, Pd, F, Na, Fe, Ni, Mn, Al, Mg, Zn, Ti, La, Ce, Sn, Zr, Ru, Si, Ge, and combinations thereof. In some embodiments, the cathode active material is not a core-shell composite.

In some embodiments, the cathode active material for a sodium-ion battery is a Prussian blue-type sodium compound that satisfies the formula NaxMyAz, wherein M is one or more metals and A is one or more anions that comprise one or more of O, P, N, C, H or a halogen. In certain embodiments, the cathode active material for a sodium-ion battery is the sodium analogue of the cathode active materials discussed above, with lithium replaced by sodium. In some embodiments, the cathode active material for a sodium-ion battery is selected from the group consisting of NaCoO₂, NaFeO₂, NaNiO₂, NaCrO₂, NaVO₂, and NaTiO₂, NaFePO₄, Na₃V₂(PO₄)₃, Na₃V₂(PO₄)₂F₃, NMC-type mixed oxides, and combinations thereof. In some embodiments, the cathode active material for a sodium-ion battery is an organic material, such as disodium naphthalenediimide, doped quinone, pteridine derivatives, polyimides, polyamic acid, or a combination thereof.

In some embodiments, the cathode active material for a sodium-ion battery comprises or is a core-shell composite having a core and shell structure. In some embodiments, the cathode active material for a sodium-ion battery is doped with a dopant. The same dopants listed above for the cathode active material for a lithium-ion battery can be used to dope the cathode active material for a sodium-ion battery.

In some embodiments, the average diameter of the cathode active material particles is from about 0.1 μm to about 100 μm, from about 50 μm to about 100 μm, from about 0.1 μm to about 50 μm, from about 0.5 μm to about 50 μm, from about 2.5 μm to about 50 μm, from about 5 μm to about 50 μm, from about 10 μm to about 50 μm, from about 15 μm to about 50 μm, from about 20 μm to about 50 μm, from about 0.5 μm to about 30 μm, from about 0.5 μm to about 20 μm, from about 1 μm to about 20 μm, from about 2.5 μm to about 20 μm, from about 5 μm to about 20 μm, from about 7.5 μm to about 20 μm, from about 10 μm to about 20 μm, or from about 15 μm to about 20 μm.

In some embodiments, the average diameter of the cathode active material particles is less than 100 μm, less than 80 μm, less than 60 μm, less than 50 μm, less than 40 μm, less than 30 μm, less than 20 μm, less than 15 μm, less than 10 μm, less than 7.5 μm, less than 5 μm, less than 2.5 μm, less than 1 μm, less than 0.75 μm, or less than 0.5 μm. In some embodiments, the average diameter of the cathode active material particles is greater than 0.1 μm, greater than 0.25 μm, greater than 0.5 μm, greater than 0.75 μm, greater than 1 μm, greater than 2.5 μm, greater than 5 μm, greater than 7.5 μm, greater than 10 μm, greater than 15 μm, greater than 20 μm, greater than 30 μm, greater than 40 μm, or greater than 50 μm.

Modified current collectors of the present invention are particularly suitable for use in cathodes where the electrode layer is formed using a water-based slurry and comprises a nickel-containing cathode active material. Such a slurry would be quite basic in nature and would therefore corrode a conventional current collector (for example, aluminum foil). However, when a basic water-based cathode slurry is coated onto a modified current collector of the present invention to form a cathode, the conductive layer in the modified current collector would form a physical barrier to prevent the conventional current collector (now the substrate of the modified current collector) from coming into contact with the slurry. Corrosion of the substrate is hence prevented. Nonetheless, modified current collectors of the present invention are suitable for use in electrodes comprising any suitable cathode active materials, for any type of battery, and using any method of formation of the electrode layer on the modified current collectors.

There are no particular limitations to the binding agent used in the electrode layer, although the binding agent should have desirable properties as a binder. Furthermore, when the electrode layer is produced with a slurry, it is preferable that the binding agent can be dispersed well in the cathode slurry to ensure an even, smooth coating. The coating of a cathode slurry comprising the binding agent used herein on the surface of the modified current collector should not be able to dissolve the underlying conductive layer within the modified current collector. In some embodiments, various types of binding agents could be used in the electrode layer, as long as they do not have a tendency to give rise to the dissolution of the conductive layer in the modified current collector. In some embodiments, the binding agent is aqueous in nature.

In some embodiments, the binding agent in the electrode layer comprises a polymer. In some embodiments, the polymer of the binding agent in the electrode layer is a copolymer. In other embodiments, the polymer of the binding agent in the electrode layer is a homopolymer.

In certain embodiments, the binding agent in the electrode layer comprises styrene-butadiene rubber (SBR), carboxymethyl cellulose (CMC), polyacrylic acid (PAA), polyacrylonitrile (PAN), polyacrylamide (PAM), acrylic acid-acrylonitrile-acrylamide copolymer, latex, a salt of alginic acid, polyvinylidene fluoride (PVDF), poly(vinylidene fluoride)-hexafluoropropene (PVDF-HFP), polytetrafluoroethylene (PTFE), polystyrene, poly(vinyl alcohol) (PVA), poly(vinyl acetate), polyisoprene, polyaniline, polyethylene, polyimide, polyurethane, polyvinyl butyral, polyvinyl pyrrolidone (PVP), gelatin, chitosan, starch, agar-agar, xanthan gum, gum arabic, gellan gum, guar gum, gum karaya, tara gum, gum tragacanth, casein, amylose, pectin, PEDOT:PSS, carrageenans, or a combination thereof. In certain embodiments, the salt of alginic acid comprises a cation selected from the group consisting of Na, Li, K, Ca, NH₄, Mg, Al, and combinations thereof. In certain embodiments, the binding agent in the electrode layer does not comprise styrene-butadiene rubber, carboxymethyl cellulose, polyacrylic acid, polyacrylonitrile, polyacrylamide, acrylic acid-acrylonitrile-acrylamide copolymer, latex, a salt of alginic acid, polyvinylidene fluoride, poly(vinylidene fluoride)-hexafluoropropene, polytetrafluoroethylene, polystyrene, poly(vinyl alcohol), poly(vinyl acetate), polyisoprene, polyaniline, polyethylene, polyimide, polyurethane, polyvinyl butyral, polyvinyl pyrrolidone, gelatin, chitosan, starch, agar-agar, xanthan gum, gum arabic, gellan gum, guar gum, gum karaya, tara gum, gum tragacanth, casein, amylose, pectin, PEDOT:PSS, or carrageenans. In certain embodiments, the binding agent in the electrode layer does not comprise a fluorine-containing polymer such as PVDF, PVDF-HFP, or PTFE.

In some embodiments, the binding agent in the electrode layer comprises one or more functional groups containing a halogen, O, N, S, or a combination thereof. Some non-limiting examples of suitable functional groups include alkoxy, aryloxy, nitro, thiol, alkylthio, imine, cyano, amide, amino (primary, secondary or tertiary), carboxyl, epoxy, ketone, aldehyde, ester, hydroxyl, halo (fluoro, chloro, bromo, or iodo), and combinations thereof. In some embodiments, the functional group is or comprises carboxylic acid (i.e., —COOH), carboxylate salt, sulfonic acid, sulfonate salt, sulfuric acid, sulfate salt, phosphonic acid, phosphonate salt, phosphoric acid, phosphate salt, nitric acid, nitrate salt, amide, hydroxyl, nitrile, ester, epoxy, or —NH₂.

In certain embodiments, the binding agent in the electrode layer comprises a copolymer comprising structural units (i), (ii), and (iii). Structural units (i) and (ii) are derived from monomers comprising hydrophilic functional groups, while structural unit (iii) is derived from monomers comprising hydrophobic functional groups. The presence of hydrophilic functional groups in the binding agent enables the copolymer to be well dispersed within aqueous solvents, as well as ensures that the various electrode components can be bound together. On the other hand, the presence of hydrophobic functional groups in the binding agent prevents the hydrophilic functional groups in the binding agent from interacting with each other, thus ensuring that the binding agent would not self-aggregate and impair dispersion, and that a cathode slurry comprising the copolymer would not be so viscous as to be difficult to process. Combining both hydrophilic and hydrophobic effects, this means that the various electrode components can be well bound together while still remaining dispersed in a water-based cathode slurry that is easy to process. Electrode layers produced using such a slurry would then be smooth and homogeneous, and batteries comprising cathodes produced therefrom would have superb capacity and electrochemical performance.

In some embodiments, the copolymer of the binding agent in the electrode layer comprises a structural unit (i) that is derived from an acid group-containing monomer, wherein the acid group is selected from the group consisting of carboxylic acid, sulfonic acid, sulfuric acid, phosphonic acid, phosphoric acid, nitric acid, and combinations thereof. The acids listed above also include their salts and derivatives. In some embodiments, the salt of the acid comprises an alkali metal cation. Examples of an alkali metal forming the alkali metal cation include lithium, sodium, and potassium. In some embodiments, the salt of the acid comprises an ammonium cation.

In some embodiments, the carboxylic acid is acrylic acid, methacrylic acid, crotonic acid, 2-butyl crotonic acid, cinnamic acid, maleic acid, maleic anhydride, fumaric acid, itaconic acid, itaconic anhydride, tetraconic acid, or a combination thereof. In certain embodiments, the carboxylic acid is 2-ethylacrylic acid, isocrotonic acid, cis-2-pentenoic acid, trans-2-pentenoic acid, angelic acid, tiglic acid, 3,3-dimethyl acrylic acid, 3-propyl acrylic acid, trans-2-methyl-3-ethyl acrylic acid, cis-2-methyl-3-ethyl acrylic acid, 3-isopropyl acrylic acid, trans-3-methyl-3-ethyl acrylic acid, cis-3-methyl-3-ethyl acrylic acid, 2-isopropyl acrylic acid, trimethyl acrylic acid, 2-methyl-3,3-diethyl acrylic acid, 3-butyl acrylic acid, 2-butyl acrylic acid, 2-pentyl acrylic acid, 2-methyl-2-hexenoic acid, trans-3-methyl-2-hexenoic acid, 3-methyl-3-propyl acrylic acid, 2-ethyl-3-propyl acrylic acid, 2,3-diethyl acrylic acid, 3,3-diethyl acrylic acid, 3-methyl-3-hexyl acrylic acid, 3-methyl-3-tert-butyl acrylic acid, 2-methyl-3-pentyl acrylic acid, 3-methyl-3-pentyl acrylic acid, 4-methyl-2-hexenoic acid, 4-ethyl-2-hexenoic acid, 3-methyl-2-ethyl-2-hexenoic acid, 3-tert-butyl acrylic acid, 2,3-dimethyl-3-ethyl acrylic acid, 3,3-dimethyl-2-ethyl acrylic acid, 3-methyl-3-isopropyl acrylic acid, 2-methyl-3-isopropyl acrylic acid, trans-2-octenoic acid, cis-2-octenoic acid, trans-2-decenoic acid, α-acetoxyacrylic acid, β-trans-aryloxyacrylic acid, α-chloro-β-E-methoxyacrylic acid, or a combination thereof.

In some embodiments, the sulfonic acid is vinylsulfonic acid, methylvinylsulfonic acid, allylvinylsulfonic acid, allylsulfonic acid, methallylsulfonic acid, styrenesulfonic acid, 2-sulfoethyl methacrylic acid, 2-methylprop-2-ene-1-sulfonic acid, 2-acrylamido-2-methyl-1-propane sulfonic acid, 3-allyloxy-2-hydroxy-1-propane sulfonic acid, or a combination thereof.

In some embodiments, the sulfuric acid is allyl hydrogen sulfate, vinyl hydrogensulfate, 4-allyl phenol sulphate, or a combination thereof.

In some embodiments, the phosphonic acid is phosphonoxyethyl acrylate, phosphonoxyethyl methacrylate, vinyl phosphonic acid, allyl phosphonic acid, 3-butenyl phosphonic acid, styrene phosphonic acid, vinyl benzyl phosphonic acid, (2-chloro-2-phenyl-vinyl)-phosphonic acid, acrylamide alkyl phosphonic acid, methacrylamide alkyl phosphonic acid, acrylamide alkyl diphosphonic acid, acryloylphosphonic acid, 2-methacryloyloxyethyl phosphonic acid, bis(2-methacryloyloxyethyl) phosphonic acid, ethylene 2-methacryloyloxyethyl phosphonic acid, ethyl-methacryloyloxyethyl phosphonic acid, or a combination thereof.

In some embodiments, the phosphoric acid is mono (2-acryloyloxyethyl) phosphate, mono (2-methacryloyloxyethyl) phosphate, diphenyl (2-acryloyloxyethyl) phosphate, diphenyl (2-methacryloyloxyethyl) phosphate, phenyl (2-acryloyloxyethyl) phosphate, phosphoxyethyl methacrylate, 3-chloro-2-phosphoryloxy propyl methacrylate, phosphoryloxy poly(ethylene glycol) monomethacrylate, phosphoryloxy poly(propylene glycol) methacrylate, (meth)acryloyloxyethyl phosphate, (meth)acryloyloxypropyl phosphate, (meth)acryloyloxy-2-hydroxypropyl phosphate, (meth)acryloyloxy-3-hydroxypropyl phosphate, (meth)acryloyloxy-3-chloro-2 hydroxypropyl phosphate, allyl hydrogen phosphate, vinyl hydrogen phosphate, allyl hydrogen pyrophosphate, vinyl hydrogen pyrophosphate, allyl hydrogen tripolyphosphate, vinyl hydrogen tripolyphosphate, allyl hydrogen tetrapolyphosphate, vinyl hydrogen tetrapolyphosphate, allyl hydrogen trimetaphosphate, vinyl hydrogen trimetaphosphate, isopentenyl phosphate, isopentenyl pyrophosphate, or a combination thereof.

In some embodiments, the nitric acid is allyl hydrogen nitrate, ethenyl hydrogen nitrate, or a combination thereof.

When the proportion of each of the various structural units of the copolymer in the binding agent is within the ranges set forth below, the combined effect of both hydrophilic functional groups and hydrophobic functional groups in the copolymer is optimized. In some embodiments, the proportion of structural unit (i) within the copolymer of the binding agent is from about 15% to about 95%, from about 15% to about 85%, from about 15% to about 75%, from about 15% to about 65%, from about 15% to about 55%, from about 20% to about 95%, from about 20% to about 90%, from about 20% to about 80%, from about 20% to about 70%, from about 20% to about 60%, from about 20% to about 50%, from about 25% to about 95%, from about 25% to about 85%, from about 25% to about 75%, from about 25% to about 65%, from about 25% to about 55%, from about 30% to about 95%, from about 30% to about 85%, from about 30% to about 75%, from about 30% to about 65%, from about 35% to about 95%, from about 35% to about 85%, from about 35% to about 75%, from about 35% to about 65%, from about 40% to about 95%, from about 40% to about 85%, from about 40% to about 75%, from about 40% to about 65%, from about 45% to about 95%, from about 45% to about 85%, from about 45% to about 75%, from about 50% to about 95%, from about 50% to about 85%, from about 50% to about 75%, from about 55% to about 95%, from about 55% to about 85%, from about 55% to about 75%, from about 60% to about 95%, or from about 60% to about 85% by mole, based on the total number of moles of monomeric units in the copolymer.

In some embodiments, the proportion of structural unit (i) within the copolymer of the binding agent is less than 95%, less than 85%, less than 75%, less than 65%, less than 55%, less than 45%, less than 35%, or less than 25% by mole, based on the total number of moles of monomeric units in the copolymer. In some embodiments, the proportion of structural unit (i) within the copolymer of the binding agent is more than 15%, more than 25%, more than 35%, more than 45%, more than 55%, more than 65%, more than 75%, or more than 85% by mole, based on the total number of moles of monomeric units in the copolymer.

In some embodiments, the copolymer of the binding agent in the electrode layer further comprises a structural unit (ii) that is derived from a monomer selected from the group consisting of an amide group-containing monomer, a hydroxyl group-containing monomer, and combinations thereof.

In some embodiments, the amide group-containing monomer is acrylamide, methacrylamide, N-methyl methacrylamide, N-ethyl methacrylamide, N-n-propyl methacrylamide, N-isopropyl methacrylamide, isopropyl acrylamide, N-n-butyl methacrylamide, N-isobutyl methacrylamide, N,N-dimethyl acrylamide, N,N-dimethyl methacrylamide, N,N-diethyl acrylamide, N,N-diethyl methacrylamide, N-methylol methacrylamide, N-(methoxymethyl)methacrylamide, N-(ethoxymethyl)methacrylamide, N-(propoxymethyl)methacrylamide, N-(butoxymethyl)methacrylamide, N,N-dimethylaminopropyl methacrylamide, N,N-dimethylaminoethyl methacrylamide, N,N-dimethylol methacrylamide, diacetone methacrylamide, diacetone acrylamide, methacryloyl morpholine, N-hydroxyl methacrylamide, N-methoxymethyl acrylamide, N-methoxymethyl methacrylamide, N,N′-methylene-bis-acrylamide (MBA), N-hydroxymethyl acrylamide, or a combination thereof.

In some embodiments, the hydroxyl group-containing monomer is an acrylate or methacrylate containing a C₁-C₂₀ alkyl or C₅-C₂₀ cycloalkyl with a hydroxyl group. In some embodiments, the hydroxyl group-containing monomer is 2-hydroxyethylacrylate, 2-hydroxyethyl methacrylate, 2-hydroxypropyl acrylate, 2-hydroxypropyl methacrylate, 2-hydroxybutyl methacrylate, 3-hydroxypropylacrylate, 3-hydroxypropylmethacrylate, 4-hydroxybutyl methacrylate, 5-hydroxypentylacrylate, 6-hydroxyhexyl methacrylate, 1,4-cyclohexanedimethanol monoacrylate, 1,4-cyclohexanedimethanol monomethacrylate, 3-chloro-2-hydroxypropyl methacrylate, diethylene glycol monoacrylate, diethylene glycol monomethacrylate, allyl alcohol, or a combination thereof.

In some embodiments, the proportion of structural unit (ii) within the copolymer of the binding agent is from about 5% to about 50%, from about 5% to about 45%, from about 5% to about 40%, from about 5% to about 35%, from about 5% to about 30%, from about 5% to about 25%, from about 10% to about 50%, from about 10% to about 45%, from about 10% to about 40%, from about 10% to about 35%, from about 10% to about 30%, from about 15% to about 50%, from about 15% to about 45%, from about 15% to about 40%, from about 20% to about 50%, from about 20% to about 45%, from about 20% to about 40%, or from about 25% to about 50% by mole, based on the total number of moles of monomeric units in the copolymer.

In some embodiments, the proportion of structural unit (ii) within the copolymer of the binding agent is less than 50%, less than 45%, less than 40%, less than 35%, less than 30%, less than 25%, less than 20%, or less than 15% by mole, based on the total number of moles of monomeric units in the copolymer. In some embodiments, the proportion of structural unit (ii) within the copolymer of the binding agent is more than 5%, more than 10%, more than 15%, more than 20%, more than 25%, more than 30%, more than 35%, or more than 40% by mole, based on the total number of moles of monomeric units in the copolymer.

In some embodiments, the copolymer of the binding agent in the electrode layer further comprises a structural unit (iii) that is derived from a monomer selected from the group consisting of a nitrile group-containing monomer, an ester group-containing monomer, an epoxy group-containing monomer, and combinations thereof.

In some embodiments, the nitrile group-containing monomer is or comprises an α,β-ethylenically unsaturated nitrile monomer. In some embodiments, the nitrile group-containing monomer is acrylonitrile, α-halogenoacrylonitrile, α-alkylacrylonitrile, or a combination thereof. In some embodiments, the nitrile group-containing monomer is α-chloroacrylonitrile, α-bromoacrylonitrile, α-fluoroacrylonitrile, methacrylonitrile, α-ethylacrylonitrile, α-isopropylacrylonitrile, α-n-hexylacrylonitrile, α-methoxyacrylonitrile, 3-methoxyacrylonitrile, 3-ethoxyacrylonitrile, α-acetoxyacrylonitrile, α-phenylacrylonitrile, α-tolylacrylonitrile, α-(methoxyphenyl)acrylonitrile, α-(chlorophenyl)acrylonitrile, α-(cyanophenyl)acrylonitrile, vinylidene cyanide, or a combination thereof.

In some embodiments, the ester group-containing monomer is C₁-C₂₀ alkyl acrylate, C₁-C₂₀ alkyl methacrylate, cycloalkyl acrylate, or a combination thereof. In some embodiments, the ester group-containing monomer is methyl acrylate, ethyl acrylate, n-propyl acrylate, isopropyl acrylate, n-butyl acrylate, sec-butyl acrylate, tert-butyl acrylate, pentyl acrylate, hexyl acrylate, heptyl acrylate, octyl acrylate, 3,3,5-trimethylhexyl acrylate, 2-ethylhexyl acrylate, nonyl acrylate, decyl acrylate, lauryl acrylate, n-tetradecyl acrylate, octadecyl acrylate, cyclohexyl acrylate, phenyl acrylate, methoxymethyl acrylate, methoxyethyl acrylate, ethoxymethyl acrylate, ethoxyethyl acrylate, perfluorooctyl acrylate, stearyl acrylate, or a combination thereof.

In some embodiments, the epoxy group-containing monomer is vinyl glycidyl ether, allyl glycidyl ether, allyl 2,3-epoxypropyl ether, butenyl glycidyl ether, butadiene monoepoxide, chloroprene monoepoxide, 3,4-epoxy-i-butene, 4,5-epoxy-2-pentene, 3,4-epoxy-1-vinylcyclohexane, 1,2-epoxy-4-vinylcyclohexane, 3,4-epoxy cyclohexylethylene, epoxy-4-vinylcyclohexene, 1,2-epoxy-5,9-cyclododecadiene, or a combination thereof.

In some embodiments, the proportion of structural unit (iii) within the copolymer of the binding agent is from about 5% to about 80%, from about 5% to about 70%, from about 5% to about 60%, from about 5% to about 50%, from about 5% to about 40%, from about 5% to about 30%, from about 10% to about 80%, from about 10% to about 70%, from about 10% to about 60%, from about 10% to about 50%, from about 10% to about 40%, from about 15% to about 80%, from about 15% to about 70%, from about 15% to about 60%, from about 15% to about 50%, from about 15% to about 40%, from about 20% to about 80%, from about 20% to about 70%, from about 20% to about 60%, from about 20% to about 50%, from about 25% to about 80%, from about 25% to about 70%, from about 25% to about 60%, from about 25% to about 50%, from about 30% to about 80%, from about 30% to about 70%, from about 30% to about 60%, from about 35% to about 80%, from about 35% to about 70%, from about 35% to about 60%, from about 40% to about 80%, from about 40% to about 70%, from about 45% to about 80%, from about 45% to about 70%, from about 50% to about 80%, or from about 50% to about 70% by mole, based on the total number of moles of monomeric units in the copolymer.

In some embodiments, the proportion of structural unit (iii) within the copolymer of the binding agent is less than 80%, less than 70%, less than 60%, less than 50%, less than 40%, less than 30%, less than 20%, or less than 15% by mole, based on the total number of moles of monomeric units in the copolymer. In some embodiments, the proportion of structural unit (iii) within the copolymer of the binding agent is more than 5%, more than 15%, more than 25%, more than 35%, more than 45%, more than 55%, or more than 60% by mole, based on the total number of moles of monomeric units in the copolymer.

In some embodiments, the electrode layer additionally comprises a conductive agent. The presence of a conductive agent enhances the electrical conductive properties of the electrode layer in a cathode. Therefore, it may be advantageous for the electrode layer to comprise a conductive agent. Any suitable material can act as a conductive agent. Any embodiments of conductive material suitable for use in the conductive layer of a modified current collector of the present invention are also suitable for use as conductive agent in the electrode layer. In other embodiments, the conductive agent is not a conductive material used in the conductive layer of a modified current collector. The conductive agent used in the electrode layer and the conductive material used in the conductive layer of a modified current collector may be the same, different, or partially different.

In some embodiments, the conductive agent comprises a conductive polymer selected from the group consisting of polypyrrole, polyaniline, polyacetylene, polyphenylene sulfide (PPS), polyphenylene vinylene (PPV), poly(3,4-ethylenedioxythiophene) (PEDOT), polythiophene, and combinations thereof. In some embodiments, the conductive polymer plays two roles simultaneously, not only as a conductive agent but also as a binder. In other embodiments, the conductive agent does not comprise a conductive polymer.

In some embodiments, the proportion of cathode active material in the electrode layer is from about 60% to about 99%, from about 70% to about 99%, from about 75% to about 99%, from about 80% to about 99%, from about 85% to about 99%, from about 90% to about 99%, from about 60% to about 95%, from about 65% to about 95%, from about 70% to about 95%, from about 75% to about 95%, from about 80% to about 95%, from about 85% to about 95%, from about 60% to about 90%, from about 65% to about 90%, from about 70% to about 90%, from about 75% to about 90%, from about 80% to about 90%, from about 60% to about 85%, from about 65% to about 85%, from about 70% to about 85%, from about 75% to about 85%, from about 60% to about 80%, from about 65% to about 80%, or from about 70% to about 80% by weight, based on the total weight of the electrode layer.

In some embodiments, the proportion of cathode active material in the electrode layer is less than 99%, less than 95%, less than 90%, less than 85%, less than 80%, less than 75%, less than 70%, or less than 65% by weight, based on the total weight of the electrode layer. In some embodiments, the proportion of cathode active material in the electrode layer is more than 60%, more than 65%, more than 70%, more than 75%, more than 80%, more than 85%, more than 90%, or more than 95% by weight, based on the total weight of the electrode layer.

In some embodiments, the proportion of binding agent and conductive agent in the electrode layer is each independently from about 1% to about 20%, from about 2% to about 20%, from about 3% to about 20%, from about 4% to about 20%, from about 5% to about 20%, from about 6% to about 20%, from about 7% to about 20%, from about 8% to about 20%, from about 9% to about 20%, from about 10% to about 20%, from about 11% to about 20%, from about 12% to about 20%, from about 13% to about 20%, from about 14% to about 20%, from about 15% to about 20%, from about 1% to about 15%, from about 2% to about 15%, from about 3% to about 15%, from about 4% to about 15%, from about 5% to about 15%, from about 6% to about 15%, from about 7% to about 15%, from about 8% to about 15%, from about 9% to about 15%, from about 10% to about 15%, from about 1% to about 10%, from about 2% to about 10%, from about 3% to about 10%, from about 4% to about 10%, from about 5% to about 10%, from about 1% to about 5%, from about 2% to about 5%, or from about 3% to about 5% by weight, based on the total weight of the electrode layer.

In some embodiments, the proportion of binding agent and conductive agent in the electrode layer is each independently less than 20%, less than 19%, less than 18%, less than 17%, less than 16%, less than 15%, less than 14%, less than 13%, less than 12%, less than 11%, less than 10%, less than 9%, less than 8%, less than 7%, or less than 6% by weight, based on the total weight of the electrode layer. In some embodiments, the proportion of binding agent and conductive agent in the electrode layer is each independently more than 1%, more than 2%, more than 3%, more than 4%, more than 5%, more than 6%, more than 7%, more than 8%, more than 9%, more than 10%, more than 11%, more than 12%, more than 13%, more than 14%, or more than 15% by weight, based on the total weight of the electrode layer.

In some embodiments, the electrode layer of a cathode may additionally comprise other additives for enhancing electrode properties. In some embodiments, the additives may include surfactants, dispersants and flexibility-enhancing additives, salts, ion conductive polymers, and inorganic solid-state electrolytes.

In certain embodiments, a cathode slurry is used to form the electrode layer of a cathode; the cathode slurry is coated onto a modified current collector of the present invention and subsequently dried. In some embodiments, the cathode slurry comprises a solvent in addition to the various electrode components that are to form the electrode layer, such as cathode active materials, binding agents and conductive agents. In some embodiments, the solvent of the cathode slurry is an aqueous solvent. Any aqueous solvent suitable for use as the solvent of a conductive slurry is also suitable for use as the solvent of a cathode slurry. In certain embodiments, when both the conductive slurry and the cathode slurry use aqueous solvents, the composition of the aqueous solvents of the two slurries may be the same, different, or partially different.

In some embodiments, the solid content of the cathode slurry is from about 40% to about 80%, from about 40% to about 75%, from about 40% to about 70%, from about 40% to about 65%, from about 40% to about 60%, from about 40% to about 55%, from about 45% to about 80%, from about 45% to about 75%, from about 45% to about 70%, from about 45% to about 65%, from about 45% to about 60%, from about 50% to about 80%, from about 50% to about 75%, from about 50% to about 70%, from about 50% to about 65%, from about 55% to about 80%, from about 55% to about 75%, from about 55% to about 70%, from about 60% to about 80%, from about 60% to about 75%, from about 65% to about 80%, from about 65% to about 75%, or from about 70% to about 80% by weight, based on the total weight of the cathode slurry.

In some embodiments, the solid content of the cathode slurry is less than 80%, less than 75%, less than 70%, less than 65%, less than 60%, less than 55%, or less than 50% by weight, based on the total weight of the cathode slurry. In some embodiments, the solid content of the cathode slurry is more than 40%, more than 45%, more than 50%, more than 55%, more than 60%, more than 65%, or more than 70% by weight, based on the total weight of the cathode slurry.

There are no particular limitations on the method used to produce a cathode slurry from the various electrode components, except that all electrode components should be mixed to form a homogeneous cathode slurry, for example through mixing in a homogenizer. In some embodiments, all the materials used to produce the cathode slurry are added into the homogenizer in a single batch. In other embodiments, each electrode component of the cathode slurry can be added to the homogenizer in one or more batches, and each batch may comprise more than one electrode component. Any homogenizer that can reduce or eliminate particle aggregation and/or promote homogeneous distribution of electrode components in the cathode slurry can be used herein. Homogeneous distribution of the electrode components in the cathode slurry plays an important role in fabricating batteries with good battery performance. In some embodiments, the homogenizer is a planetary stirring mixer, a stirring mixer, a blender, or an ultrasonicator.

There are no particular limitations to the conditions used to form the cathode slurry, except such conditions should be sufficient to produce a homogenous slurry with good dispersion of the electrode components within the slurry. There are no particular limitations on the time taken or the temperature or stirring speed used to homogenize the cathode slurry, except that the time period, temperature and stirring speed should be sufficient to ensure homogeneous distribution of the various electrode components in the cathode slurry and that the cathode slurry can be processed easily.

In some embodiments, after homogenization of a cathode slurry, the cathode slurry can be coated onto one side or both sides of a modified current collector of the present invention to form an electrode layer. There are no particular limitations to the equipment and the conditions used in coating the slurry, except that a homogeneous, flat and smooth electrode layer film should be formed. In certain embodiments, the coating process is performed using a doctor blade coater, a slot-die coater, a transfer coater, a spray coater, a roll coater, a gravure coater, a dip coater, or a curtain coater. In some embodiments, the cathode slurry is applied directly onto a modified current collector. In other embodiments, the cathode slurry is first applied onto a release film to form a free-standing electrode layer. The free-standing electrode layer is then combined with a modified current collector and pressed to form an electrode layer.

In some embodiments, following the coating of the cathode slurry onto a modified current collector of the present invention, the coating is dried. Any equipment that can dry the coating in order to affix the electrode layer onto the modified current collector can be used herein.

There are no particular limitations to the conditions used for drying, except that the drying conditions should be sufficient to ensure that the electrode layer adheres strongly to the modified current collector. However, drying the cathode slurry at temperatures above 150° C. may result in undesirable deformation of the cathode, thus affecting the cathode's performance. In some embodiments, the resultant cathode is compressed mechanically following drying of the film in order to increase the density of the cathode.

In certain embodiments, the thickness of the electrode layer is from about 5 μm to about 90 μm, from about 5 μm to about 50 μm, from about 5 μm to about 25 μm, from about 10 μm to about 90 μm, from about 10 μm to about 50 μm, from about 10 μm to about 30 μm, from about 15 μm to about 90 μm, from about 20 μm to about 90 μm, from about 25 μm to about 90 μm, from about 25 μm to about 80 μm, from about 25 μm to about 70 μm, from about 25 μm to about 50 μm, from about 30 μm to about 90 μm, or from about 30 μm to about 80 μm. In some embodiments, the thickness of the electrode layer is more than 5 μm, more than 10 μm, more than 15 μm, more than 20 μm, more than 25 μm, more than 30 μm, more than 40 μm, more than 50 μm, more than 60 μm, more than 70 μm, or more than 80 μm. In some embodiments, the thickness of the electrode layer is less than 90 μm, less than 80 μm, less than 70 μm, less than 60 μm, less than 50 μm, less than 40 μm, less than 30 μm, less than 25 μm, less than 20 μm, less than 15 μm, or less than 10 μm.

In some embodiments, the surface density of the electrode layer is from about 1 mg/cm² to about 50 mg/cm², from about 2.5 mg/cm² to about 50 mg/cm², from about 5 mg/cm² to about 50 mg/cm², from about 10 mg/cm² to about 50 mg/cm², from about 15 mg/cm² to about 50 mg/cm², from about 20 mg/cm² to about 50 mg/cm², from about 30 mg/cm² to about 50 mg/cm², from about 1 mg/cm² to about 30 mg/cm², from about 2.5 mg/cm² to about 30 mg/cm², from about 5 mg/cm² to about 30 mg/cm², from about 10 mg/cm² to about 30 mg/cm², from about 15 mg/cm² to about 30 mg/cm², from about 20 mg/cm² to about 30 mg/cm², from about 1 mg/cm² to about 20 mg/cm², from about 2.5 mg/cm² to about 20 mg/cm², from about 5 mg/cm² to about 20 mg/cm², from about 10 mg/cm² to about 20 mg/cm², from about 1 mg/cm² to about 15 mg/cm², from about 2.5 mg/cm² to about 15 mg/cm², from about 5 mg/cm² to about 15 mg/cm², or from about 10 mg/cm² to about 15 mg/cm².

In some embodiments, the surface density of the electrode layer is less than 50 mg/cm², less than 40 mg/cm², less than 30 mg/cm², less than 20 mg/cm², less than 15 mg/cm², less than 10 mg/cm², less than 5 mg/cm², or less than 2.5 mg/cm². In some embodiments, the surface density of the electrode layer is more than 1 mg/cm², more than 2.5 mg/cm², more than 5 mg/cm², more than 10 mg/cm², more than 15 mg/cm², more than 20 mg/cm², more than 30 mg/cm², or more than 40 mg/cm².

In a cathode comprising a modified current collector of the present invention, the electrode layer exhibits strong adhesion to the modified current collector. It is important for the electrode layer to have a high peeling strength with respect to the modified current collector, as this prevents delamination or separation of the cathode, which would greatly impact the mechanical stability of the cathode and the cyclability of a battery comprising the cathode. Therefore, the cathodes should have sufficient peeling strength to withstand the rigors of battery manufacture.

In some embodiments, the peeling strength between the electrode layer and the modified current collector is from about 1.0 N/cm to about 8.0 N/cm, from about 1.0 N/cm to about 6.0 N/cm, from about 1.0 N/cm to about 5.0 N/cm, from about 1.0 N/cm to about 4.0 N/cm, from about 1.0 N/cm to about 3.0 N/cm, from about 1.0 N/cm to about 2.5 N/cm, from about 1.0 N/cm to about 2.0 N/cm, from about 2.0 N/cm to about 8.0 N/cm, from about 2.0 N/cm to about 6.0 N/cm, from about 2.0 N/cm to about 5.0 N/cm, from about 2.0 N/cm to about 3.0 N/cm, from about 3.0 N/cm to about 8.0 N/cm, from about 3.0 N/cm to about 6.0 N/cm, or from about 4.0 N/cm to about 6.0 N/cm.

In some embodiments, the peeling strength between the electrode layer and the modified current collector is more than 1.0 N/cm, more than 1.2 N/cm, more than 1.5 N/cm, more than 2.0 N/cm, more than 2.2 N/cm, more than 2.5 N/cm, more than 3.0 N/cm, more than 3.5 N/cm, more than 4.0 N/cm, more than 4.5 N/cm, more than 5.0 N/cm, more than 5.5 N/cm, more than 6.0 N/cm, more than 6.5 N/cm, or more than 7.0 N/cm. In some embodiments, the peeling strength between the electrode layer and the modified current collector is less than 8.0 N/cm, less than 7.5 N/cm, less than 7.0 N/cm, less than 6.5 N/cm, less than 6.0 N/cm, less than 5.5 N/cm, less than 5.0 N/cm, less than 4.5 N/cm, less than 4.0 N/cm, less than 3.5 N/cm, less than 3.0 N/cm, less than 2.8 N/cm, less than 2.5 N/cm, less than 2.2 N/cm, less than 2.0 N/cm, less than 1.8 N/cm, or less than 1.5 N/cm.

In some embodiments, once a cathode comprising a modified current collector is formed, the cathode can be assembled with an anode and an electrolyte to form a battery.

In some embodiments, the electrolyte is a liquid electrolyte. Such a liquid electrolyte comprises an electrolyte solvent and a salt. In some embodiments, the electrolyte solvent is water; the liquid electrolyte is then an aqueous electrolyte. In other embodiments, the electrolyte solvent is a liquid composed of one or more organic solvents; the liquid electrolyte is then a non-aqueous electrolyte. In some embodiments, each organic solvent is selected from a carbonate-based, ester-based, ether-based or other aprotic solvent. Some non-limiting examples of the carbonate-based solvent include dimethyl carbonate, diethyl carbonate, dipropyl carbonate, methylpropyl carbonate, ethylpropyl carbonate, ethyl methyl carbonate, ethylene carbonate, propylene carbonate, butylene carbonate, and combinations thereof. Some non-limiting examples of the ester-based solvent include methyl acetate, methyl propanoate, ethyl acetate, n-propyl acetate, dimethyl acetate, methyl propionate, ethyl propionate, and combinations thereof. Some non-limiting examples of the ether-based solvent include dibutyl ether, tetraglyme, diglyme, dimethoxyethane, 2-methyltetrahydrofuran, tetrahydrofuran, and combinations thereof. Some non-limiting examples of the other aprotic solvent include methyl bromide, ethyl bromide, methyl formate, acetonitrile, dimethyl sulfoxide, dimethylformamide, N-methyl-2-pyrrolidone, and combinations thereof.

In some embodiments, the liquid electrolyte is for a lithium-ion battery. The salt in the liquid electrolyte is then a lithium salt. In some embodiments, the lithium salt present in the liquid electrolyte for a lithium-ion battery is selected from the group consisting of LiPF₆, LiBO₂, LiBF₄, LiSbF₆, LiAsF₆, LiAlCl₄, LiClO₄, LiCl, LiI, LiNO₃, LiB(C₂O₄)₂, LiSO₃CF₃, LiN(SO₂F)₂, LiN(SO₂CF₃)₂, LiN(SO₂CF₂CF₃)₂, LiC₂H₃O₂, and combinations thereof.

In some embodiments, the liquid electrolyte is for a sodium-ion battery. The salt in the liquid electrolyte is then a sodium salt. In some embodiments, the sodium salt present in the liquid electrolyte for a sodium-ion battery is the sodium analogue of the lithium salts discussed above, with the lithium replaced by sodium. Such sodium salts include NaPF₆, NaBF₄, NaN(SO₂CF₃)₂, NaN(SO₂F)₂, NaClO₄, NaSO₃CF₃, and combinations thereof. In some embodiments, the salt present in the liquid electrolyte for a sodium-ion battery is one or more of NaMFₓ; wherein each x is 4 or 6; and wherein each M is selected from the group consisting of Al³⁺, B³⁺, Ga³⁺, In³⁺, Sc³⁺, Y³⁺, La³⁺, P⁵⁺, As⁵⁺, and combinations thereof.

In some embodiments, the electrolyte is a solid-state electrolyte. In some embodiments, the solid-state electrolyte is a polymer electrolyte. Such a polymer electrolyte comprises an ion-conductive polymer as well as a salt. Any known polymer electrolyte can be used in the invention disclosed herein. Some non-limiting examples of the ion-conductive polymer include polyether, polycarbonate, polyacrylate, polysiloxane, polyphosphazene, polyethylene derivative, alkylene oxide derivative, phosphate polymer, poly-lysine, polyester sulfide, polyvinyl alcohol, and polyvinylidene fluoride. Some non-limiting examples of the salt of the polymer electrolyte include the lithium and sodium salts mentioned above for the liquid electrolyte.

In some embodiments, the solid-state electrolyte is an inorganic solid-state electrolyte. Any known inorganic solid-state electrolyte can be used. Some non-limiting examples include sulfides, lithium superionic conductor (LISICON) type compounds, lithium lanthanum titanate (LLTO) type compounds, and perovskite compounds.

In some embodiments, the solid-state electrolyte is a gel electrolyte. Such a gel electrolyte comprises a polymer electrolyte and an electrolyte solvent.

Due to the presence of the conductive layer in the modified current collector of the present invention, batteries comprising cathodes that use the modified current collector exhibit exceptional electrochemical performance. Compared to a conventional current collector, a modified current collector of the present invention brings about considerable improvement to the cathode, such improvement being made possible by the contribution of each individual component present in the conductive layer. More specifically, the conductive material decreases the interfacial resistance between the modified current collector and the electrode layer, thereby reducing the overall internal resistance of the resultant cathode and minimizing capacity losses arising therefrom. The conductive layer also acts as a physical barrier to prevent corrosion of the substrate. The binder material not only provides more effective binding capability between the conductive material particles and between the conductive material particles and the substrate, but also improves the mechanical strength of the cathode as a whole. Furthermore, when a water-based slurry is used to produce the conductive layer, the binder material within the conductive layer still maintains excellent binding properties even if an aqueous cathode slurry is subsequently applied on the conductive layer, and the conductive layer does not disintegrate or delaminate from the substrate. The particulate material, when present, acts to enhance the binding properties of the binder material, thereby further improving the performance of the modified current collector of the present invention. Meanwhile, the metal compound in the conductive layer compensates for metal ions lost in initial charging during SEI formation, thereby effectively reducing irreversible capacity losses of the battery without affecting the structure of the electrode layer or forming undesirable decomposition side products in the electrode layer, both of which could adversely affect battery performance.

The following examples are presented to exemplify embodiments of the invention but are not intended to limit the invention to the specific embodiments set forth. Unless indicated to the contrary, all parts and percentages are by weight. All numerical values are approximate. When numerical ranges are given, it should be understood that embodiments outside the stated ranges may still fall within the scope of the invention. Specific details described in each example should not be construed as necessary features of the invention.

While the invention has been described with respect to a limited number of embodiments, the specific features of one embodiment should not be attributed to other embodiments of the invention. In some embodiments, the methods may include numerous steps not mentioned herein. In other embodiments, the methods do not include, or are substantially free of, any steps not enumerated herein. Variations and modifications from the described embodiments exist. The appended claims intend to cover all those modifications and variations as falling within the scope of the invention.

### EXAMPLES

The viscosity of the binder material used in the conductive layer were measured using a rotational viscometer (NDJ-5S, Shanghai JT Electronic Technology Co. Ltd., China) at 4% concentration in DI water and 20° C. Rotor type no. 1 was used, and the viscometer was operated at a speed of 60 rpm.

### Example 1

### A) Preparation of Conductive Material Mixture

150 g of graphite powder (obtained from Timcal Ltd, Bodio, Switzerland) was added into 500 g of DI water. After the addition, the mixture was stirred for about 5 mins at 25° C. at a speed of 1000 rpm to form a conductive material mixture.

### B) Preparation of Binder Material Solution

A binder material was prepared by the following method. Homopolymer prepared by the polymerization of acetoxyethene is added to a methanol solution of NaOH and reacted at about 50° C. to produce a precursor of the copolymer. The precursor is dried, and then added to a 25 g/L solution of NaOH and mixed to react for about 1 hour at a temperature below 20° C. The reaction product is then washed, filtered and dried at about 90° C. to obtain the binder material. In the structural unit (a) of the copolymer, any three of R₁, R₂, R₃ and R₄ are H; and any one of R₁, R₂, R₃ and R₄ is hydroxyl. In the structural unit (b) of the copolymer, any three of R₅, R₆, R₇ and R₈ are H; and any one of R₅, R₆, R₇ and R₈ is acetoxy. The proportions of structural unit (a) and structural unit (b) in the copolymer of the binder material are 99% and 1% by mole respectively, based on the total number of moles of monomeric units in the copolymer. The weight-average molecular weight of the copolymer (M_{w}) is 200,000 g/mol. The viscosity of the binder material at 4% concentration in DI water at 20° C. is 66 mPa·s. The components of the binder material of Example 1 and their respective proportions are shown in Table 1 below.

40 g of the binder material was then added into 700 g of DI water and heated to 70° C. The mixture was stirred at 600 rpm for 30 mins using a magnetic stirrer to form an intermediate solution. Thereafter, 35 g of metal compound, lithium acetate, was added to the intermediate solution, and the mixture was further stirred at 600 rpm for 30 minutes to form a binder material solution. The solid content of the binder material solution is 9.7% by weight.

### C) Preparation of Conductive Slurry

111 g of the binder material solution was added into 50 g of the conductive material mixture. After the addition, the mixture was stirred for about 30 mins at 25° C. at a speed of 1000 rpm to form a conductive slurry. The solid content of the conductive slurry is 13.9% by weight.

### D) Preparation of Modified Current Collector

An aluminum foil having a thickness of 16 μm was used as a substrate. The conductive slurry was coated onto both sides of the substrate using a doctor blade coater with a gap width of 8 μm. The coated slurry of 4.5 μm on the aluminum foil was dried to form a conductive layer using a box-type resistance oven under vacuum (DZF-6020, obtained from Shenzhen Kejing Star Technology Co. Ltd., China) at 100° C. The drying time was about 30 mins.

### E) Preparation of Binding Agent Solution

16 g of sodium hydroxide (NaOH) was added into a round-bottom flask containing 380 g of distilled water. The sodium hydroxide solution was stirred at 80 rpm for 30 mins to obtain a first suspension.

36.04 g of acrylic acid was added into the first suspension. The mixture was further stirred at 80 rpm for 30 mins to obtain a second suspension.

19.04 g of acrylamide (AM) was dissolved in 10 g of DI water to form an AM solution. Thereafter, 29.04 g of AM solution was added into the second suspension. The mixture was further heated to 55° C. and stirred at 80 rpm for 45 mins to obtain a third suspension.

12.92 g of acrylonitrile (AN) was added into the third suspension. The mixture was further stirred at 80 rpm for 10 mins to obtain a fourth suspension.

Furthermore, 0.015 g of water-soluble free radical initiator (ammonium persulfate, APS; obtained from Aladdin Industries Corporation, China) was dissolved in 3 g of DI water and 0.0075 g of reducing agent (sodium bisulfite; obtained from Tianjin Damao Chemical Reagent Factory, China) was dissolved in 1.5 g of DI water. 3.015 g of APS solution and 1.5075 g of sodium bisulfite solution were added into the fourth suspension. The mixture was stirred at 200 rpm for 24 h at 55° C. to obtain a fifth suspension.

After the complete reaction, the temperature of the fifth suspension was lowered to 25° C. 3.72 g of NaOH was dissolved in 400 g of DI water. Thereafter, 403.72 g of sodium hydroxide solution was added dropwise into the fifth suspension to adjust pH to 7.31 to form the sixth suspension. The binding agent was filtered using 200 μm nylon mesh. The solid content of the binding agent solution is 9.00 wt. %.

### F) Preparation of Positive Electrode

A first mixture was prepared by dispersing 12 g of conductive agent (SuperP; obtained from Timcal Ltd, Bodio, Switzerland) and 100 g of the binding agent solution (9.00 wt. % solid content) in 74 g of deionized water while stirring with an overhead stirrer (R₂₀, IKA). After the addition, the first mixture was further stirred for about 30 mins at 25° C. at a speed of 1,200 rpm.

Thereafter, a second mixture was prepared by adding 276 g of lithium nickel manganese oxide LNMO (LiMn_{0.5}Ni₅O₄) (obtained from Chengdu Xingneng New Materials Co., Ltd, China) to the first mixture at 25° C. while stirring with an overhead stirrer. Then, the second mixture was degassed under a pressure of about 10 kPa for 1 hour. The second mixture was further stirred for about 60 mins at 25° C. at a speed of 1,200 rpm to form a homogenized cathode slurry.

The homogenized cathode slurry was coated onto one side of the surface of the modified current collector prepared above using a doctor blade coater with a gap width of 120 μm. The coated slurry of 80 μm on the modified current collector was dried to form a cathode layer using an electrically heated oven at 70° C. The drying time was about 10 mins. The electrode was then pressed to decrease the thickness of the cathode layer to 23 μm. The surface density of the cathode layer on the modified current collector is 7.00 mg/cm².

### G) Preparation of Negative Electrode

A negative electrode slurry was prepared by mixing 90 wt. % of graphite (BTR New Energy Materials Inc., Shenzhen, Guangdong, China) with 1.5 wt. % carboxymethyl cellulose (CMC, BSH-12, DKS Co. Ltd., Japan) and 3.5 wt. % SBR (AL-2001, NIPPON A&L INC., Japan) as a binder, and 5 wt. % carbon black as a conductive agent in deionized water. The solid content of the anode slurry was 50 wt. %. The slurry was coated onto one side of a copper foil having a thickness of 8 μm using a doctor blade coater with a gap width of about 55 μm. The coated film on the copper foil was dried at about 50° C. for 120 minutes by a hot air dryer to obtain a negative electrode. The electrode was then pressed to decrease the thickness of the coating to 12 μm and the surface density was 3.2 mg/cm².

### H) Assembly of Coin Cell

CR2032 coin-type Li cells were assembled in an argon-filled glove box. The coated cathode and anode sheets were cut into disc-form positive and negative electrodes and dried in a box-type resistance oven under vacuum (DZF-6020, obtained from Shenzhen Kejing Star Technology Co. Ltd., China) at 105° C. for about 16 hours. The cathode and anode were kept apart by a separator. The separator was a ceramic coated microporous membrane made of nonwoven fabric (MPM, Japan), which had a thickness of about 25 μm.

An electrolyte was then injected into the case holding the packed electrodes under a high-purity argon atmosphere with a moisture and oxygen content of less than 3 ppm respectively. After electrolyte filling, the coin cell was mechanically pressed using a punch tooling with a standard circular shape.

### I) Electrochemical Measurements

The coin cells were analyzed in a constant current mode using a multi-channel battery tester (BTS-4008-5V10mA, obtained from Neware Electronics Co. Ltd, China). After 1 cycle at C/20 was completed, they were charged and discharged at a rate of C/2. The charging/discharging cycling tests of the cells were performed between 3.0 and 4.9 V at a current density of C/2 at 25° C. to obtain the discharge capacity. The electrochemical performance of the coin cell of Example 1 was measured and is shown in Table 1 below.

### Preparation of Conductive Material Mixture of Examples 2-7 and 11-18, and Comparative Examples 1-2 and 4-5

The conductive material mixtures of Examples 2-7 and 11-18 and Comparative Examples 1-2 and 4-5 were prepared in the same manner as in Example 1.

### Preparation of Conductive Material Mixture of Example 8

The conductive material mixture was prepared in the same manner as in Example 1, except that 25 g of carbon black was first added into 500 g of DI water, which was stirred for 15 mins at 25° C. at a speed of 1000 rpm to form a mixture; 125 g of graphite powder was then added into the mixture and was further stirred for 60 mins at 25° C. at a speed of 1000 rpm to form a conductive material mixture.

### Preparation of Conductive Material Mixture of Example 9

The conductive material mixture was prepared in the same manner as in Example 1, except that 25 g of vapor grown carbon nanofibers (VGCFs; obtained from Showa Denko K.K., Japan) was first added into 500 g of DI water, which was stirred for 15 mins at 25° C. at a speed of 1000 rpm to form a mixture; 125 g of graphite powder was then added into the mixture and was further stirred for 60 mins at 25° C. at a speed of 1000 rpm to form a conductive material mixture.

### Preparation of Conductive Material Mixture of Example 10

The conductive material mixture was prepared in the same manner as in Example 1, except that 25 g of carbon nanotubes (CNTs; obtained from Jiangsu Cnano Technology Co. Ltd., China) was first added into 500 g of DI water, which was stirred for 15 mins at 25° C. at a speed of 1000 rpm to form a mixture; 125 g of graphite powder was then added into the mixture and was further stirred for 60 mins at 25° C. at a speed of 1000 rpm to form a conductive material mixture.

### Preparation of Conductive Material Mixture of Comparative Example 3

The conductive material mixture was prepared in the same manner as in Example 1, except that 500 g of NMP was used instead of the same weight of DI water.

### Preparation of Binder Material Solution of Example 2

The binder material solution was prepared in the same manner as in Example 1, except that the weight-average molecular weight of the copolymer is 130,000 g/mol. The viscosity of the binder material at 4% concentration in DI water at 20° C. is 30 mPa·s.

### Preparation of Binder Material Solution of Example 3

The binder material solution was prepared in the same manner as in Example 1, except that the weight-average molecular weight of the copolymer is 20,000 g/mol. The viscosity of the binder material at 4% concentration in DI water at 20° C. is 6 mPa·s.

### Preparation of Binder Material Solution of Example 4

The binder material solution was prepared in the same manner as in Example 1, except that some conditions were changed so that the proportions of structural unit (a) and structural unit (b) in the copolymer of the binder material are 98% and 2% by mole respectively, based on the total number of moles of monomeric units in the copolymer. The weight-average molecular weight of the copolymer is 110,000 g/mol. The viscosity of the binder material at 4% concentration in DI water at 20° C. is 20 mPa·s.

### Preparation of Binder Material Solution of Example 5

The binder material solution was prepared in the same manner as in Example 1, except that some conditions were changed so that the proportions of structural unit (a) and structural unit (b) in the copolymer of the binder material are 96% and 4% by mole respectively, based on the total number of moles of monomeric units in the copolymer. The weight-average molecular weight of the copolymer is 78,000 g/mol. The viscosity of the binder material at 4% concentration in DI water at 20° C. is 17 mPa·s.

### Preparation of Binder Material Solution of Example 6

The binder material solution was prepared in the same manner as in Example 1, except that some conditions were changed so that the proportions of structural unit (a) and structural unit (b) in the copolymer of the binder material are 94% and 6% by mole respectively, based on the total number of moles of monomeric units in the copolymer. The weight-average molecular weight of the copolymer is 80,000 g/mol. The viscosity of the binder material at 4% concentration in DI water at 20° C. is 17 mPa·s.

### Preparation of Binder Material Solution of Example 7

The binder material solution was prepared in the same manner as in Example 1, except that some conditions were changed so that the proportions of structural unit (a) and structural unit (b) in the copolymer of the binder material are 92% and 8% by mole respectively, based on the total number of moles of monomeric units in the copolymer. The weight-average molecular weight of the copolymer is 82,000 g/mol. The viscosity of the binder material at 4% concentration in DI water at 20° C. is 17 mPa·s.

### Preparation of Binder Material Solution of Examples 8-10

The binder material solutions were prepared in the same manner as Example 2.

### Preparation of Binder Material Solution of Example 11

The binder material was prepared in the same manner as in Example 1. 37 g of the binder material was then added into 700 g of DI water and heated to 70° C. The mixture was stirred at 600 rpm for 30 mins using a magnetic stirrer to form a first intermediate solution. Thereafter, 3 g of SiO₂ (obtained from Aladdin Industries Corporation, China) with a specific surface area of 400 m²/g and an average diameter of around 7-40 nm was added to the intermediate solution, and the mixture was further stirred at 600 rpm for 30 minutes to form a second intermediate solution. Afterwards, 35 g of metal compound, lithium acetate, was added to the second intermediate solution, and the mixture was further stirred at 600 rpm for 30 minutes to form a binder material solution. The solid content of the binder material solution is 9.7% by weight.

### Preparation of Binder Material Solution of Example 12

The binder material solution was prepared in the same manner as Example 1, except that 51 g of lithium lactate was used instead of 35 g of lithium acetate.

### Preparation of Binder Material Solution of Example 13

The binder material solution was prepared in the same manner as Example 1, except that 28 g of lithium formate was used instead of 35 g of lithium acetate.

### Preparation of Binder Material Solution of Example 14

The binder material solution was prepared in the same manner as Example 1, except that 35 g of lithium oxalate was used instead of 35 g of lithium acetate.

### Preparation of Binder Material Solution of Example 15

The binder material solution was prepared in the same manner as Example 1, except that 35 g of lithium succinate was used instead of 35 g of lithium acetate.

### Preparation of Binder Material Solution of Example 16

The binder material solution was prepared in the same manner as Example 1, except that 40 g of lithium citrate was used instead of 35 g of lithium acetate.

### Preparation of Binder Material Solution of Example 17

The binder material solution was prepared in the same manner as Example 1, except that 28 g of lithium nitrite was used instead of 35 g of lithium acetate.

### Preparation of Binder Material Solution of Example 18

The binder material solution was prepared in the same manner as Example 1, except that 36 g of lithium azide was used instead of 35 g of lithium acetate.

### Preparation of Binder Material Solution of Comparative Examples 1-2

The binder material solutions were prepared in the same manner as Example 1, except that 75 g of the binder material of Example 1 was added, and no lithium acetate was added in the preparation of the binder material solution.

### Preparation of Binder Material Solution of Comparative Example 3

40 g of poly(vinylidene fluoride) (PVDF; obtained from Sigma-Aldrich, Germany) was added into 700 g of NMP. The mixture was stirred using a magnetic stirrer to form an intermediate solution. Thereafter, 35 g of metal compound, lithium acetate was added to the intermediate solution, and the mixture was further stirred at 600 rpm for 30 minutes to form a binder material solution. The solid content of the binder material solution is 9.7% by weight.

### Preparation of Binder Material Solution of Comparative Example 4

The binder material solution was prepared in the same manner as in Example 1, except that some conditions were changed so that the proportions of structural unit (a) and structural unit (b) in the copolymer of the binder material are 89% and 11% by mole respectively, based on the total number of moles of monomeric units in the copolymer. The weight-average molecular weight of the copolymer is 75,000 g/mol. The viscosity of the binder material at 4% concentration in DI water at 20° C. is 13 mPa·s.

### Preparation of Binder Material Solution of Comparative Example 5

114.29 g of 35% polyacrylic acid solution (PAA; obtained from Sigma-Aldrich, Germany) was added to 625.71 g of DI water. The mixture was stirred at 600 rpm for 30 mins using a magnetic stirrer to form an intermediate solution. Thereafter, 35 g of metal compound, lithium acetate was added to the intermediate solution, and the mixture was further stirred at 600 rpm for 30 minutes to form a binder material solution. The solid content of the binder material solution is 9.7% by weight.

### Preparation of Conductive Slurry of Examples 2-18 and Comparative Examples 1-5

The conductive slurries of Examples 2-18 and Comparative Examples 1-5 were prepared in the same manner as in Example 1.

### Preparation of Modified Current Collector of Examples 2-18 and Comparative Examples 1-5

The modified current collectors of Examples 2-18 and Comparative Examples 1-5 were prepared in the same manner as in Example 1.

### Preparation of Binding Agent Solution of Examples 2-18 and Comparative Examples 1-3

The binding agent solutions of Examples 2-18 and Comparative Examples 1-3 were prepared in the same manner as in Example 1.

### Preparation of Positive Electrode of Examples 2-16 and Comparative Examples 2-3

The positive electrodes of Examples 2-16 and Comparative Examples 2-3 were prepared in the same manner as in Example 1.

### Preparation of Positive Electrode of Examples 17-18 and Comparative Example 1

The positive electrodes were prepared in the same manner as in Example 1, except that 276 g of LNMO was replaced with NMC811 of the same weight (obtained from Shandong Tianjiao New Energy Co., Ltd, China) in the preparation of the positive electrode.

### Preparation of Positive Electrode of Comparative Example 4-5

It was observed that a viable modified current collector could not be produced for Comparative Examples 4 and 5. Therefore, cathodes of Comparative Example 4-5 were not prepared, coin cells were not assembled, and no further electrochemical measurements were taken.

### Preparation of Negative Electrodes of Examples 2-18, and Comparative Examples 1-3

Negative electrodes were prepared by the same method described in Example 1. Assembly of Coin Cell of Examples 2-18 and Comparative Examples 1-3

The coin cells of Examples 2-18 and Comparative Examples 1-3 were assembled in the same manner as in Example 1.

### Electrochemical Measurements of Examples 2-16 and Comparative Examples 2-3

The electrochemical performance of the coin cells of Examples 2-16 and Comparative Examples 2-3 were measured in the same manner as in Example 1, and the test results are shown in Table 1 below.

### Electrochemical Measurements of Examples 17-18 and Comparative Example 1

The electrochemical performance of the coin cells of Examples 17-18 and Comparative Example 1 were measured in the same manner as in Example 1, except that the charging/discharging cycling tests of the cells were performed between 3.0 and 4.2 V at a current density of C/2 at 25° C. to obtain the discharge capacity. The test results are shown in Table 1 below.

TABLE 1

| | Conductive layer | | | | | | | | |
|---|---|---|---|---|---|---|---|---|---|
| | | | Binder material | | | | | 0.5C Initial | Capacity |
| | | | Proportion of | Proportion of | | | | discharging | retention |
| | Conductive material | | structural | structural | | | Cathode active | capacity | after 50 |
| | Material 1 | Material 2 | unit (a) | unit (b) | M_{w} (g/mol) | Metal compound | material | (mAh/g) | cycles (%) |
| Example 1 | Graphite | — | 99 | 1 | 200.000 | Lithium acetate | LNMO | 117 | 82.4 |
| Example 2 | Graphite | — | 99 | 1 | 130.000 | Lithium acetate | LNMO | 116 | 83.1 |
| Example 3 | Graphite | — | 99 | 1 | 20.000 | Lithium acetate | LNMO | 117 | 82.3 |
| Example 4 | Graphite | — | 98 | 2 | 110.000 | Lithium acetate | LNMO | 118 | 81.6 |
| Example 5 | Graphite | — | 96 | 4 | 78.000 | Lithium acetate | LNMO | 115 | 82.3 |
| Example 6 | Graphite | — | 94 | 6 | 80.000 | Lithium acetate | LNMO | 116 | 83.1 |
| Example 7 | Graphite | — | 92 | 8 | 82.000 | Lithium acetate | LNMO | 115 | 82.1 |
| Example 8 | Graphite | Carbon black | 99 | 1 | 130.000 | Lithium acetate | LNMO | 120 | 85.4 |
| Example 9 | Graphite | VGCFs | 99 | 1 | 130.000 | Lithium acetate | LNMO | 119 | 85.4 |
| Example 10 | Graphite | CNTs | 99 | 1 | 130.000 | Lithium acetate | LNMO | 120 | 86.1 |
| Example 11 | Graphite | — | 99 | 1 | 130.000 | Lithium acetate | LNMO | 123 | 86.5 |
| Example 12 | Graphite | — | 99 | 1 | 130.000 | Lithium lactate | LNMO | 119 | 81.2 |
| Example 13 | Graphite | — | 99 | 1 | 130.000 | Lithium formate | LNMO | 117 | 83.1 |
| Example 14 | Graphite | — | 99 | 1 | 130.000 | Lithium oxalate | LNMO | 119 | 83.6 |
| Example 15 | Graphite | — | 99 | 1 | 130.000 | Lithium succinate | LNMO | 116 | 80.1 |
| Example 16 | Graphite | — | 99 | 1 | 130.000 | Lithium citrate | LNMO | 114 | 80.2 |
| Example 17 | Graphite | — | 99 | 1 | 130.000 | Lithium nitrite | NMC811 | 185 | 90.2 |
| Example 18 | Graphite | — | 99 | 1 | 130.000 | Lithium azide | NMC811 | 186 | 88.3 |
| Comparative | Graphite | — | 99 | 1 | 130.000 | — | NMC811 | 174 | 78.2 |
| Example 1 | | | | | | | | | |
| Comparative | Graphite | — | 99 | 1 | 130.000 | — | LNMO | 110 | 72.5 |
| Example 2 | | | | | | | | | |
| Comparative | Graphite | — | —¹ | —¹ | —¹ | Lithium acetate | LNMO | 113 | 64.9 |
| Example 3 | | | | | | | | | |
| Comparative | Graphite | — | 89 | 11 | 75.000 | Lithium acetate | —³ | —3 | —³ |
| Example 4 | | | | | | | | | |
| Comparative | Graphite | — | —² | —² | —² | Lithium acetate | —³ | —3 | —³ |
| Example 5 | | | | | | | | | |

¹PVDF was used as the binder material instead.
²Polyacrylic acid was used as the binder material instead.
³A viable cathode could not be produced.

1. A modified current collector for a secondary battery, comprising a substrate and a conductive layer applied on one side or both sides of the substrate, wherein the conductive layer comprises a conductive material, and a metal compound represented by formula (1):
[A⁺]ₐB^{a-} (1)
wherein cation A⁺ is Li⁺ or Na⁺, a is an integer from 1 to 10, and anion B^{a-} is an inorganic or organic anion.

2. The modified current collector of claim 1, wherein anion B^{a-} is an inorganic anion selected from the group consisting of azide, nitrite, chloride, bromide, iodide, borate, metaborate, fluoroborate, perchlorate and combinations thereof; and wherein anion B^{a-} is an organic anion selected from the group consisting of deltate, squarate, croconate, rhodizonate, bis(trifluoromethanesulfonyl)imide, bis(fluorosulfonyl)imide, difluoro(oxalato)borate, and bis(oxalato)borate, and combinations thereof.

3. The modified current collector of claim 1, wherein anion B^{a-} is an organic anion comprising one or more carboxylate or carboxylic acid groups.

4. The modified current collector of claim 3, wherein the organic anion is selected from the group consisting of formate, acetate, propionate, butyrate, pentanoate, oxalate, malonate, succinate, glutarate, adipate, pimelate, hydrogenoxalate, hydrogenmalonate, hydrogensuccinate, hydrogenglutarate, hydrogenadipate, hydrogenpimelate, citrate, hydrogencitrate, dihydrogencitrate, lactate, ketomalonate, ketosuccinate, hydrogenketomalonate, hydrogenketosuccinate, 3,4-dihydroxybenzoate, 3,4-dihydroxybutyrate, isomers thereof, and combinations thereof.

5. The modified current collector of claim 1, wherein the conductive material is selected from the group consisting of carbon, carbon black, graphite, expanded graphite, graphene, graphene nanoplatelets, carbon fibers, carbon nano-fibers, graphitized carbon flake, carbon tubes, carbon nanotubes, activated carbon, Super P, KS6, vapor grown carbon fibers, mesoporous carbon, and combinations thereof.

6. The modified current collector of claim 1, wherein the amount of the metal compound in the conductive layer is from about 5% to about 30% by weight, based on the total weight of the conductive layer; and wherein the amount of the conductive material in the conductive layer is from about 25% to about 75% by weight, based on the total weight of the conductive layer.

7. The modified current collector of claim 1, wherein the conductive layer further comprises a binder material, and wherein the binder material comprises a copolymer comprising a structural unit (a), wherein the structural unit (a) comprises one or more monomeric unit(s) with formula (2): 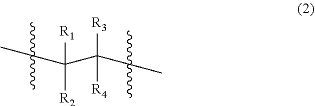
and wherein each of R₁, R₂, R₃ and R₄ in formula (2) is independently H, hydroxyl, alkyl, hydroxyalkyl, halogen, or alkyl halide.

8. The modified current collector of claim 7, wherein the hydroxyalkyl is selected from the group consisting of hydroxymethyl, hydroxyethyl, hydroxypropyl, hydroxy (methyl) propyl, hydroxy (methyl) butyl, and combinations thereof.

9. The modified current collector of claim 7, wherein the copolymer further comprises a structural unit (b), wherein the structural unit (b) comprises one or more monomeric unit(s) with formula (3): 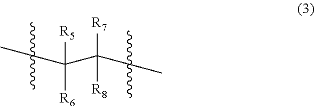
and wherein each of R₅, R₆, R₇ and R₈ in formula (3) is independently H, alkyl, acyloxy, acyloxyalkyl, halogen, or alkyl halide.

10. The modified current collector of claim 9, wherein the acyloxyalkyl is selected from the group consisting of acyloxymethyl, acyloxyethyl, acyloxypropyl, acyloxy (methyl) propyl, acyloxy (methyl) butyl, and combinations thereof.

11. The modified current collector of claim 7, wherein the proportion of the structural unit (a) in the copolymer is at least 90% by mole, based on the total number of moles of monomeric units in the copolymer.

12. The modified current collector of claim 7, wherein the proportion of the structural unit (a) in the copolymer is from about 90% to about 99.9% by mole, based on the total number of moles of monomeric units in the copolymer.

13. The modified current collector of claim 9, wherein the proportion of the structural unit (b) in the copolymer is from about 0.1% to about 10% by mole, based on the total number of moles of monomeric units in the copolymer.

14. The modified current collector of claim 9, wherein the weight-average molecular weight of the copolymer is from about 10,000 g/mol to about 300,000 g/mol; and wherein the proportion of the copolymer in the conductive layer is from about 25% to about 75% by weight, based on the total weight of the conductive layer.

15. The modified current collector of claim 1, wherein the conductive layer further comprises a particulate material, wherein the particulate material is selected from the group consisting of Fe₂O₃, Fe₃O₄, FeO(OH), MnO₂, Al₂O₃, AlO(OH), ZnO, La₂O₃, CeO₂, RuO₂, SiO₂, TiO₂, ZrO₂, Mg(OH)₂, MgO, SnO₂, CaCO₃, BaSO₄, TiN, AlN, Na₂O·mTiO₂, K₂O·nTiO₂, BaOₓ, MTiO₃, and combinations thereof; wherein m is 3 or 6; n is 1, 2, 4, 6, or 8; x is 1 or 2; and M is Ba, Sr, or Ca; and wherein the amount of the particulate material in the conductive layer is from about 0.5% to about 5% by weight, based on the total weight of the conductive layer.

16. The modified current collector of claim 1, wherein the substrate is selected from the group consisting of stainless steel, titanium, nickel, aluminum, copper, platinum, gold, silver, chromium, zirconium, tungsten, molybdenum, silicon, tin, vanadium, zinc, cadmium, or alloys thereof, electrically-conductive resin, and combinations thereof.

17. A cathode, comprising the modified current collector of claim 1 and an electrode layer, wherein the electrode layer is located on the surface of the conductive layer, and wherein the electrode layer comprises a cathode active material and a binding agent.

18. The cathode of claim 17, wherein the cathode active material is selected from the group consisting of LiCoO₂, LiNiO₂, LiNi₁₋ₓMₓO₂, LiNiₓMn_{y}O₂, LiCoₓNi_{y}O₂, Li_{1+z}NiₓMn_{y}Co_{1-x-y}O₂, LiNiₓCo_{y}Al_{z}O₂, LiV₂O₅, LiTiS₂, LiMoS₂, LiMnO₂, LiCrO₂, LiMn₂O₄, Li₂MnO₃, LiFeO₂, LiFePO₄, and combinations thereof; wherein each x is independently from 0.1 to 0.9; each y is independently from 0 to 0.9; each z is independently from 0 to 0.4; and wherein M is selected from the group consisting of Co, Mn, Al, Fe, Ti, Ga, Mg, and combinations thereof.

19. The cathode of claim 17, wherein the cathode active material is selected from the group consisting of NaCoO₂, NaFeO₂, NaNiO₂, NaCrO₂, NaVO₂, NaTiO₂, NaFePO₄, Na₃V₂(PO₄)₃, Na₃V₂(PO₄)₂F₃, NMC-type mixed oxides, Prussian blue-type sodium compounds, and combinations thereof; and wherein the binding agent comprises a polymer comprising one or more functional groups containing a halogen, O, N, S, or a combination thereof.

20. The cathode of claim 19, wherein each functional group is independently selected from the group consisting of carboxylic acid, carboxylate salt, sulfonic acid, sulfonate salt, sulfuric acid, sulfate salt, phosphonic acid, phosphonate salt, phosphoric acid, phosphate salt, nitric acid, nitrate salt, amide, hydroxyl, nitrile, ester, epoxy, —NH₂, and combinations thereof.
